(19) United States
(12) Patent Application Publication
(10) Pub. No.: US 2022/0355189 A1
(43) Pub. Date: Nov. 10, 2022

(54) GAME PROGRAM, GAME METHOD, AND INFORMATION PROCESSING DEVICE

(71) Applicant: COLOPL, INC., Tokyo (JP)

(72) Inventor: Yusuke Ikeda, Tokyo (JP)

(21) Appl. No.: 17/635,637

(22) PCT Filed: Aug. 6, 2020
(86) PCT No.: PCT/JP2020/030180

§ 371 Date: Jun. 23, 2022

(30) Foreign Application Priority Data
Aug. 16, 2019 (JP) 2019-149380

(51) Int. Cl. A63F 13/2145; G06F 3/04817; G06F 3/0488; G06F 3/0482; G06F 3/04847; A63F 13/537; A63F 13/55

(52) U.S. Cl. CPC A63F 13/2145; G06F 3/04817; G06F 3/0488; G06F 3/0482; G06F 3/04847; A63F 13/537; A63F 13/55; A63F 13/812

(57) ABSTRACT

The value of a first parameter is updated while a touch operation on a touch screen is continued. A first game control is executed when a first touch operation is received from a user and then a second touch operation is received after a touch operation of updating the value of the first parameter to a first value is released.

### TECHNICAL FIELD

The present invention relates to a game program, a game method, and an information processing device.

### BACKGROUND ART

A conventional game device is known in which after a touch operation is performed for a predetermined charge completion time or longer, when another touch operation is performed after the touch operation is released, a predetermined control such as a charge shot stronger than a normal shot is performed (PTL 1).

### CITATION LIST

### Patent Literature

PTL 1: Japanese Patent No. 6450875

### SUMMARY OF INVENTION

### Technical Problem

However, in the conventional game device, there is a possibility that a predetermined control may be performed at a timing not intended by the user due to an erroneous operation after the charge is completed, and there is room for improvement.

The present invention has been conceived in view of such circumstances, and an object thereof is to provide a game program, a game method, and an information processing device that can prevent a predetermined control from being performed at an unintended timing as much as possible.

### Solution to Problem

An aspect of an embodiment of the present disclosure provides a game program that is executed on a computer including a processor, a memory, and a touch screen, the processor being caused to execute: a step of updating a value of a first parameter while a first touch operation on the touch screen is continued; and a step of executing a first game control when a second touch operation is received from a user and then a third touch operation is received after the first touch operation is released.

### Advantageous Effects of Invention

According to the present invention, it is possible to prevent a first game control from being performed at an unintended timing as much as possible.

### BRIEF DESCRIPTION OF DRAWINGS

FIG. 1 is a diagram showing a hardware configuration of a game system.

FIG. 2 is a block diagram showing a functional configuration of a server.

FIG. 3 is a block diagram showing a functional configuration of a user terminal.

FIG. 4A is a diagram showing an example of a match space, which is a kind of game space in a tennis game realized by a game system.

FIG. 4B is a diagram showing an example of a match space, which is a kind of game space in a tennis game realized by a game system.

FIG. 5A is a diagram showing an example of a display screen displayed on a touch screen by a display control unit of a user terminal, and FIG. 5B is a diagram showing another example of the display screen displayed on the touch screen by the display control unit of the user terminal.

FIG. 6A is a diagram showing an example of a display screen displayed on a touch screen by a display control unit of a user terminal, FIG. 6B is a diagram showing another example of a display screen displayed on the touch screen by the display control unit of the user terminal, FIG. 6C is a diagram showing still another example of a display screen displayed on the touch screen by the display control unit of the user terminal, and FIG. 6D is a diagram showing still another example of a display screen displayed on the touch screen by the display control unit of the user terminal.

FIG. 7A is a diagram showing an example of a display screen displayed on a touch screen by a display control unit of a user terminal, FIG. 7B is a diagram showing another example of a display screen displayed on the touch screen by the display control unit of the user terminal, FIG. 7C is a diagram showing still another example of a display screen displayed on the touch screen by the display control unit of the user terminal, and FIG. 7D is a diagram showing still another example of a display screen displayed on the touch screen by the display control unit of the user terminal.

FIG. 8 is a flowchart showing an example of a processing flow in a user terminal.

### DESCRIPTION OF EMBODIMENTS

A game system according to the present disclosure is a system for providing a game to a plurality of users. Hereinafter, the game system will be described with reference to the drawings. The invention is defined by the claims rather than being restricted to these examples, and is intended to include all modifications within the meaning and range of equivalency of the claims. In the following description, the same elements will be denoted by the same reference numerals in the description of the drawings, and duplicate description will not be repeated.

<Hardware Configuration of Game System 1>

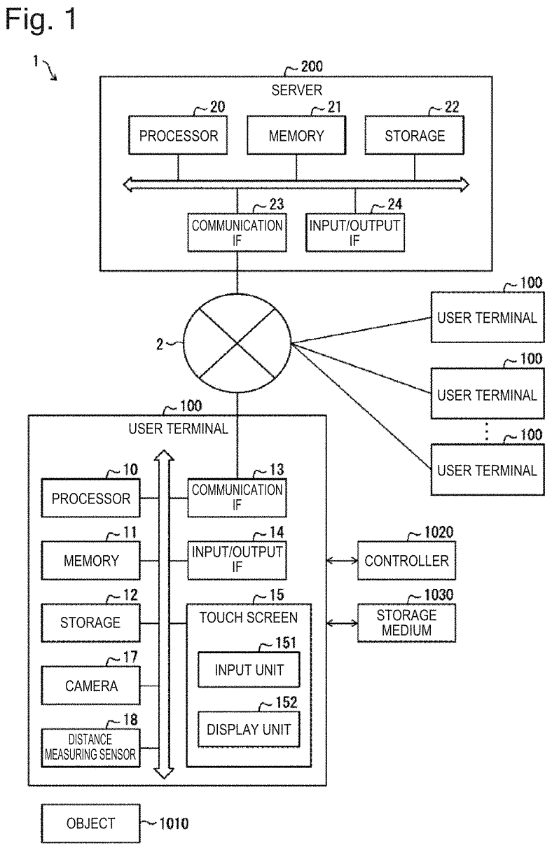

FIG. 1 is a diagram showing a hardware configuration of the game system 1. As shown in the drawing, the game system 1 includes a plurality of user terminals 100 and a server 200. Each user terminal 100 is connected to the server 200 via a network 2. The network 2 is configured of various mobile communication systems constructed by the Internet and a radio base station (not shown). Examples of this mobile communication system include so-called 3G and 4G mobile communication systems, long term evolution (LTE), and wireless networks (for example, Wi-Fi (registered trademark)) that can be connected to the Internet by a predetermined access point.

The server 200 (computer, information processing device) may be a general-purpose computer such as a workstation or a personal computer. The server 200 includes a processor 20, a memory 21, a storage 22, a communication IF 23, and an input/output IF 24. These components of the server 200 are electrically connected to each other by a communication bus.

The user terminal 100 (computer, information processing device) may be a mobile terminal such as a smartphone, a feature phone, a Personal digital assistant (PDA), or a tablet computer. The user terminal 100 may be a game device suitable for game play. As shown in the drawing, the user terminal 100 includes a processor 10, a memory 11, a storage 12, a communication interface (IF) 13, an input/output IF 14, a touch screen 15 (display unit), a camera 17, and a distance measuring sensor 18. These components of the user terminal 100 are electrically connected to each other by a communication bus. The user terminal 100 may be provided with an input/output IF 14 to which a display (display unit) configured separately from the main body of the user terminal 100 can be connected, in place of or in addition to the touch screen 15.

Further, as shown in FIG. 1, the user terminal 100 may be configured to be communicable with one or more controllers 1020. The controller 1020 establishes communication with the user terminal 100, for example, in accordance with a communication standard such as Bluetooth (registered trademark). The controller 1020 may have one or more buttons or the like, and transmits an output value based on a user's input operation on the buttons or the like to the user terminal 100. The controller 1020 may have various sensors such as an acceleration sensor and an angular velocity sensor, and transmits the output values of the sensors to the user terminal 100.

In addition, the controller 1020 may have the camera 17 and the distance measuring sensor 18, instead of or in addition to the user terminal 100 having the camera 17 and the distance measuring sensor 18.

It is desirable that the user terminal 100 causes a user who uses the controller 1020 to input user identification information such as the user's name or login ID via the controller 1020, for example, at the start of a game. In this way, the user terminal 100 can associate the controller 1020 with the user, and can identify the user to which the output value belongs based on the source (the controller 1020) of the received output value.

When the user terminal 100 communicates with a plurality of controllers 1020, a multi-player game can be realized with one user terminal 100 without communicating with another device such as the server 200 via the network 2 by allowing the users to grip the controllers 1020. In addition, a multi-player game may be realized locally by a plurality of user terminals 100 by allowing the user terminals 100 to communicate with each other according to a wireless standard such as a wireless local area network (LAN) standard (communication connection is made without via the server 200). When the multi-player game is realized locally by one user terminal 100, the user terminal 100 may further include at least some of various functions described later, of the server 200. Further, when the multi-player game is realized locally by a plurality of user terminals 100, the plurality of user terminals 100 may be provided with various functions described later, of the server 200 in a distributed manner.

Even when the multi-player game is realized locally, the user terminal 100 may communicate with the server 200. For example, information indicating a play result such as a record or a win or loss in a certain game may be associated with user identification information and transmitted to the server 200.

The controller 1020 may be configured to be removable from the user terminal 100. In this case, a coupling portion with the controller 1020 may be provided on at least one surface of the housing of the user terminal 100. When the user terminal 100 and the controller 1020 are connected by wire via the coupling portion, the user terminal 100 and the controller 1020 transmit and receive signals via wire.

As shown in FIG. 1, the user terminal 100 may receive the attachment of a storage medium 1030 such as an external memory card via the input/output IF 14. In this way, the user terminal 100 can read the program and data recorded on the storage medium 1030. The program recorded on the storage medium 1030 is, for example, a game program.

The user terminal 100 may store the game program acquired by communicating with an external device such as the server 200 in the memory 11 of the user terminal 100, or may store the game program acquired by reading from the storage medium 1030 in the memory 11.

As described above, the user terminal 100 includes a communication IF 13, an input/output IF 14, a touch screen 15, a camera 17, and a distance measuring sensor 18 as an example of a mechanism for inputting information to the user terminal 100. Each of the parts as an input mechanism can be regarded as an operating unit configured to receive a user's input operation.

For example, when the operating unit is configured of at least one of the camera 17 and the distance measuring sensor 18, the operating unit detects an object 1010 in the vicinity of the user terminal 100 and identifies an input operation from the detection result of the object. As an example, a user's hand, a marker having a predetermined shape, or the like is detected as the object 1010, and an input operation is identified based on the color, shape, movement, or type of the object 1010 obtained as the detection result. More specifically, when the user's hand is detected from the captured image from the camera 17, the user terminal 100 identifies and receives a gesture (a series of movements of the user's hand) detected based on the captured image as the user's input operation. The captured image may be a still image or a moving image.

Alternatively, when the operating unit is configured of the touch screen 15, the user terminal 100 identifies and receives the user's operation performed on the input unit 151 of the touch screen 15 as the user's input operation. Alternatively, when the operating unit is configured of the communication IF 13, the user terminal 100 identifies and receives a signal (for example, an output value) transmitted from the controller 1020 as the user's input operation. Alternatively, when the operating unit is configured of the input/output IF 14, the user terminal 100 identifies and receives a signal output from an input device (not shown) different from the controller 1020 connected to the input/output IF 14 as the user's input operation.

<Hardware Components of Each Device>

The processor 10 controls the operation of the entire user terminal 100. The processor 20 controls the operation of the entire server 200. The processors 10 and 20 include a central processing unit (CPU), a micro processing unit (MPU), and a graphics processing unit (GPU).

The processor 10 reads a program from the storage 12 described later and expands it into the memory 11 described later. The processor 20 reads a program from the storage 22 described later and expands it into the memory 21 described later. The processor 10 and processor 20 execute the expanded program.

The memories 11 and 21 are the main storage devices. The memories 11 and 21 are configured of a storage device such as a read only memory (ROM) and a random access memory (RAM). The memory 11 provides a work area to the processor 10 by temporarily storing a program and various pieces of data read from the storage 12 described later by the processor 10. The memory 11 also temporarily stores various pieces of data generated while the processor 10 is operating according to the program. The memory 21 provides a work area to the processor 20 by temporarily storing various pieces of data and programs read from the storage 22 described later by the processor 20. The memory 21 also temporarily stores various pieces of data generated while the processor 20 is operating according to the program.

In the present embodiment, the program may be a game program for realizing the game by the user terminal 100. Alternatively, the program may be a game program for realizing the game by cooperation of the user terminal 100 and the server 200. The game realized by the cooperation of the user terminal 100 and the server 200 may be, for example, a game executed on a browser started on the user terminal 100. Alternatively, the program may be a game program for realizing the game by cooperation of a plurality of user terminals 100. Further, various pieces of data include data related to the game such as user information and game information, and instructions or notifications to be transmitted/received between the user terminal 100 and the server 200 or between a plurality of user terminals 100.

The storages 12 and 22 are auxiliary storage devices. The storages 12 and 22 are configured of a storage device such as a flash memory or a hard disk drive (HDD). Various pieces of data related to the game are stored in the storage 12 and the storage 22.

The communication IF 13 controls the transmission/reception of various pieces of data in the user terminal 100. The communication IF 23 controls the transmission/reception of various pieces of data in the server 200. The communication IFs 13 and 23 control, for example, communication via a wireless local area network (LAN), Internet communication via a wired LAN, a wireless LAN, or a mobile phone network, and communication using short-range wireless communication.

The input/output IF 14 is an interface for the user terminal 100 to receive data input, and an interface for the user terminal 100 to output data. The input/output IF 14 may input/output data via a universal serial bus (USB) or the like. The input/output IF 14 may include, for example, a physical button, a camera, a microphone, a speaker, or the like of the user terminal 100. The input/output IF 24 of the server 200 is an interface for the server 200 to receive data input, and an interface for the server 200 to output data. The input/output IF 24 may include, for example, an input unit that is an information input device such as a mouse or a keyboard, and a display unit that is a device that displays and outputs an image.

The touch screen 15 of the user terminal 100 is an electronic component that combines an input unit 151 and a display unit 152. The input unit 151 is, for example, a touch-sensitive device, and is configured of, for example, a touch pad. The display unit 152 is configured of, for example, a liquid crystal display, an organic electro-luminescence (EL) display, or the like.

The input unit 151 has a function of detecting a position where a user's operation (mainly a physical contact operation such as a touch operation, a slide operation, a swipe operation, and a tap operation) is input to the input surface, and transmitting information indicating the position as an input signal. The input unit 151 may include a touch sensing unit (not shown). The touch sensing unit may adopt any method such as a capacitance method or a resistance film method.

Although not shown, the user terminal 100 may include one or more sensors for identifying the holding posture of the user terminal 100. This sensor may be, for example, an acceleration sensor, an angular velocity sensor, or the like. When the user terminal 100 includes a sensor, the processor 10 can also identify the holding posture of the user terminal 100 from the output of the sensor and perform processing according to the holding posture. For example, the processor 10 may set vertical screen display in which a vertically long image is displayed on the display unit 152 when the user terminal 100 is held vertically. On the other hand, the processor 10 may set horizontal screen display in which a horizontally long image is displayed on the display unit when the user terminal 100 is held horizontally. In this way, the processor 10 may be able to switch between the vertical screen display and the horizontal screen display according to the holding posture of the user terminal 100.

The camera 17 includes an image sensor and the like, and generates a captured image by converting the incident light incident from the lens into an electric signal.

The distance measuring sensor 18 is a sensor that measures the distance to the object to be measured. The distance measuring sensor 18 includes, for example, a light source that emits pulse-converted light and a light receiving element that receives the light. The distance measuring sensor 18 measures the distance to the object to be measured based on the timing of light emission from the light source and the timing of receiving the reflected light generated by the light emitted from the light source being reflected by the object to be measured. The distance measuring sensor 18 may have a light source that emits light having directivity.

Here, an example in which the user terminal 100 receives the detection result of detecting an object 1010 in the vicinity of the user terminal 100 using the camera 17 and the distance measuring sensor 18 as an input operation of the user will be further described. The camera 17 and the distance measuring sensor 18 may be provided on the side surface of the housing of the user terminal 100, for example. The distance measuring sensor 18 may be provided in the vicinity of the camera 17. As the camera 17, for example, an infrared camera can be used. In this case, the camera 17 may be provided with a lighting device that irradiates infrared rays, a filter that blocks visible light, and the like. In this way, it is possible to further improve the detection accuracy of the object based on the captured image from the camera 17, regardless of whether it is outdoors or indoors.

The processor 10 may perform one or more of the processes (1) to (5), for example, on the captured image from the camera 17. (1) The processor 10 specifies whether the captured image includes a user's hand by performing image recognition processing on the captured image from the camera 17. The processor 10 may use, for example, a technique such as pattern matching as the analysis technique adopted in the image recognition processing. (2) The processor 10 detects the user's gesture from the shape of the user's hand. The processor 10 specifies, for example, the number of fingers of the user (the number of extended fingers) from the shape of the user's hand detected from the captured image. The processor 10 further identifies the gesture performed by the user from the specified number of fingers. For example, the processor 10 determines that the user has made a “paper” gesture when the number of fingers is five. Further, when the number of fingers is 0 (the finger is not detected), the processor 10 determines that the user has made a “rock” gesture. Further, when the number of fingers is two, the processor 10 determines that the user has made a “scissors” gesture. (3) The processor 10 detects whether the user's finger is in a state in which only the index finger is raised or whether the user's finger is flicking by performing image recognition processing on the captured image from the camera 17. (4) The processor 10 detects the distance between the user terminal 100 and the object 1010 (user's hand or the like) in the vicinity of the user terminal 100 based on at least one of the image recognition result of the captured image from the camera 17 and the output value of the distance measuring sensor 18. For example, the processor 10 detects whether the user's hand is in the vicinity of (for example, a distance less than a predetermined value) or at a distance (for example, a distance equal to or greater than a predetermined value) from the user terminal 100 based on the size of the shape of the user's hand specified from the captured image from the camera 17. When the captured image is a moving image, the processor 10 may detect whether the user's hand is approaching or moving away from the user terminal 100. (5) When it is found that the distance between the user terminal 100 and the user's hand is changing in a state in which the user's hand is detected based on the image recognition result of the captured image from the camera 17, the processor 10 recognizes that the user is waving his/her hand in the shooting direction of the camera 17. When an object is detected or not detected in the distance measuring sensor 18 having a stronger directivity than the shooting range of the camera 17, the processor 10 recognizes that the user is waving his/her hand in a direction orthogonal to the shooting direction of the camera.

In this way, the processor 10 detects whether the user is making a fist (whether it is a “rock” gesture or another gesture (for example, “paper”)) by performing image recognition on the captured image from the camera 17. In addition, the processor 10 detects the shape of the user's hand and how the user is moving the hand. In addition, the processor 10 detects whether the user is moving this hand toward or away from the user terminal 100. Such an operation can correspond to an operation using a pointing device such as a mouse or a touch panel, for example. For example, the user terminal 100 moves the pointer on the touch screen 15 in response to the movement of the user's hand, and detects the user's gesture “rock”. In this case, the user terminal 100 recognizes that the user is continuing the selection operation. The continuation of the selection operation corresponds to, for example, continuation of the state in which the mouse is clicked and pressed, or continuation of the state in which a touch-down operation is performed on a touch panel and the state is maintained. Further, when the user further moves his/her hand in a state in which the user's gesture “rock” is detected, the user terminal 100 may recognize such a series of gestures as an operation corresponding to a swipe operation (or a drag operation). Further, when the user terminal 100 detects a gesture that the user flicks a finger based on the detection result of the user's hand by the captured image from the camera 17, the user terminal 100 may recognize the gesture as an operation corresponding to a mouse-click operation or a tap operation on a touch panel.

<Functional Configuration of Game System 1>

(Functional Configuration of Server 200)

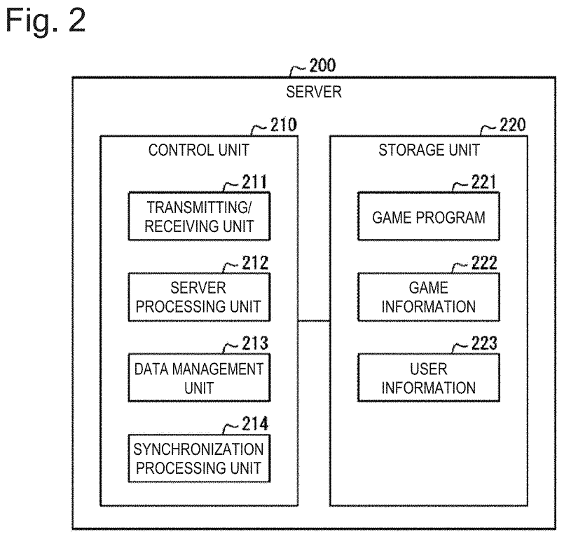

FIG. 2 is a block diagram showing a functional configuration of the server 200. The server 200 has a function of providing various pieces of data and programs necessary for realizing a game to each user terminal 100. The server 200 has a function of collecting and managing data related to the game from each user terminal 100. The server 200 has a function of performing synchronization processing between a plurality of user terminals 100.

In the present embodiment, the server 200 identifies each user and each user terminal 100 by a game account registered in advance. A method of registering an account is not particularly limited. For example, the user terminal 100 or another device such as a personal computer may transmit the information necessary for registering the user's account to the server 200 according to the user's operation. Then, the server 200 may create and save each user's account based on the received information.

When the user terminal 100 logs in to the network 2 of the game system 1 using any of the accounts, the server 200 recognizes the logged-in user terminal 100. The login method and the processes related to the login are not particularly limited. The server 200 and the user terminal 100 may perform conventionally known login methods and various processes related to login.

The server 200 functions as a control unit 210 and a storage unit 220 by the cooperation of the processor 20, the memory 21, the storage 22, the communication IF 23, the input/output IF 24, and the like.

The storage unit 220 stores various pieces of data used by the control unit 210. The storage unit 220 stores a game program 221, game information 222, and user information 223.

The game program 221 is a program for realizing a game. The game information 222 and the user information 223 are data referred to when the game program 221 is executed.

The game program 221 may include, in addition to the game program executed on the server 200 side, a program (the game program 121 described later) transmitted to the user terminal 100 and executed on the user terminal 100 side. Alternatively, the storage unit 220 may store both the game program 221 executed on the server 200 side and the program executed on the user terminal side.

The game information 222 is information common to all accounts. The game information 222 may include, for example, information for defining various game spaces. The “game space” is a space in which an object of an operating character that can be operated by the user is arranged. The game information 222 may include various pieces of setting information about the object common to all accounts, such as the arrangement position, size, color, shape, and the like of background objects such as trees, rocks, buildings, and the like arranged in the game space and a non-player character (NPC) object. The game information 222 may include setting values of various parameters of the non-player character. The game information 222 may include information related to quests. The game information 222 may include information regarding the winning probability of a lottery performed in the game space. A quest is an in-game event for which achievement conditions are set. Achievement conditions may be set for each quest. In addition to the achievement conditions, failure conditions may be set for the quest. In the following, the object of the character arranged in the game space may be referred to simply as a “character”.

The user information 223 is information managed for each game account. The user information 223 may include, for example, information on an operable character (hereinafter referred to as an operating character), information on owned assets, information indicating the degree of progress of the game, and the like. Here, examples of owned assets include in-game currency, items, character equipment, and the like.

The control unit 210 controls various processes related to the game by executing the game program 221 stored in the storage unit 220. The control unit 210 functions as a transmitting/receiving unit 211, a data management unit 213, and a server processing unit 212 by executing the game program 221.

The transmitting/receiving unit 211 transmits/receives various pieces of data. For example, the transmitting/receiving unit 211 receives a transmission request for various pieces of data and programs from the user terminal 100, a synchronization request for supporting the multi-player function, data for synchronization, and the like, and transmits the received data and requests to the server processing unit 212. For example, the transmitting/receiving unit 211 transmits various pieces of data and programs to the user terminal 100 according to the instruction from the server processing unit 212.

In the present embodiment, the “multi-player function” is a function for advancing a game in a state in which the progress of the game is synchronized between a plurality of accounts. When a plurality of accounts logged in to the game system 1 exist, the server 200 and the user terminal 100 of the game system 1 perform various processes for supporting the multi-player function.

The server processing unit 212 performs various determination processes related to the progress of the game. The server processing unit 212 performs arithmetic processing necessary for providing the game. The server processing unit 212 executes the arithmetic processing described in the game program 221 in response to a request from the user terminal 100 or the like.

For example, the server processing unit 212 instructs the data management unit 213 to add, update, or delete the record of the game information 222 or the user information 223. For example, the server processing unit 212 instructs the transmitting/receiving unit 211 to transmit various pieces of data or programs. For example, when the server processing unit 212 receives a synchronization request for supporting the multi-player function and data for synchronization from the user terminal 100 via the transmitting/receiving unit 211, the server processing unit 212 instructs the synchronization processing unit 214 to perform synchronization processing for supporting the multi-player function.

The data management unit 213 manages various pieces of data stored in the storage unit 220 according to the instruction of the server processing unit 212. For example, the data management unit 213 adds, updates, or deletes the record of the game information 222 or the user information 223 in response to an instruction from the server processing unit 212.

For example, the data management unit 213 reads at least one of the game information 222 and the user information 223 from the storage unit 220 according to the instruction from the server processing unit 212, and transmits the same to the user terminal 100 via the transmitting/receiving unit 211.

For example, the data management unit 213 reads out a program of the game program 221 to be executed on the user terminal 100 side from the storage unit 220 according to the instruction from the server processing unit 212, and transmits the same to the user terminal 100 via the transmitting/receiving unit 211.

The synchronization processing unit 214 performs synchronization processing for supporting the multi-player function of the game according to the instruction of the server processing unit 212. The synchronization processing unit 214 synchronizes user terminals by transmitting some information received from the user terminal 100 corresponding to each account to another user terminal 100. Even when some information is transmitted from the server 200 to the plurality of user terminals 100, the synchronization processing unit 214 transmits the information to the respective user terminal 100 in synchronization. The synchronization processing unit 214 may receive synchronization timing, information to be synchronized, and the like from the server processing unit 212. In this way, for example, the in-game action caused by the input operation performed in a certain user terminal 100 is shown synchronously in another user terminal 100.

(Functional Configuration of User Terminal 100)

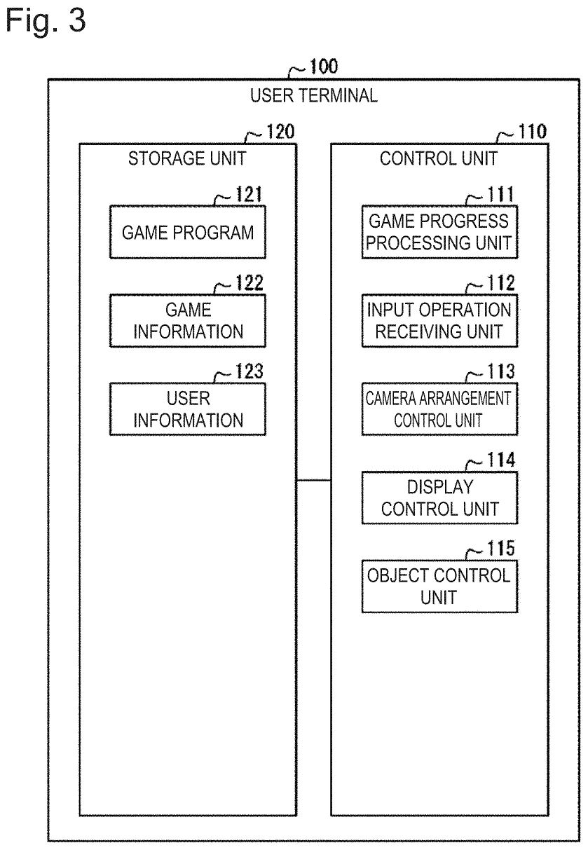

FIG. 3 is a block diagram showing a functional configuration of the user terminal 100. The user terminal 100 has a function as an input device that receives a user's input operation and a function as an output device that outputs a game image or sound. The user terminal 100 functions as a control unit 110 and a storage unit 120 by the cooperation of the processor 10, the memory 11, the storage 12, the communication IF 13, the input/output IF 14, and the like.

The storage unit 120 stores a game program 121, game information 122, and user information 123. The game program 121 is a game program executed on the user terminal 100 side. The game information 122 is data referred to when the control unit 110 executes the game program 121, and includes the same information as the game information 222 of the server 200. The user information 123 is data related to the user account of the user terminal 100, and includes the same information as the user information 223 of the server 200.

The control unit 110 comprehensively controls the user terminal 100 by executing the game program 121 stored in the storage unit 120. For example, the control unit 110 defines a game space with reference to the information for defining the game space, stored in the game information 122. The control unit 110 transmits and receives various pieces of data. For example, the control unit 110 receives various pieces of data and programs, synchronization data for supporting the multi-player function from the server 200. For example, the control unit 110 transmits a part or all of the game information 122 or the user information 123, or a synchronization request for supporting the multi-player function to the server 200.

The control unit 110 functions as a game progress processing unit 111, an input operation receiving unit 112, a camera arrangement control unit 113, a display control unit 114, and an object control unit 115 according to the description of the game program 121.

The input operation receiving unit 112 detects and receives a user's input operation with respect to the input unit 151. The input operation receiving unit 112 determines what kind of input operation has been performed from the action exerted by the user on the console via the touch screen 15 and other input/output IF 14, and outputs the determination result to each element of the control unit 110.

For example, when an input operation is performed on the input unit 151, the input operation receiving unit 112 detects the coordinates of the input position and the type of operation. For example, the input operation receiving unit 112 detects a touch operation, a slide operation, a swipe operation, a tap operation, and the like. When an input operation detected continuously is interrupted, the input operation receiving unit 112 detects that a contact input is released from the touch screen 15.

The game progress processing unit 111 performs various processes related to the progress of the game. For example, the game progress processing unit 111 analyzes the content of the user's instruction indicated by the coordinates of the input position and the type of the operation of the input operation received by the input operation receiving unit 112. For example, the game progress processing unit 111 adds, updates, or deletes the game information 122 or the user information 123. For example, the game progress processing unit 111 performs various determination processes related to the progress of the game.

The camera arrangement control unit 113 defines a virtual camera for specifying a region to be presented to the user in the game space. The camera arrangement control unit 113 virtually arranges the virtual camera in the game space by defining the position and direction of the virtual camera in the game space. The camera arrangement control unit 113 instructs the display control unit 114 to create an image in which the field-of-view region defined by the virtual camera and the objects arranged in the field-of-view region are drawn.

The camera arrangement control unit 113 may appropriately determine the position and direction of the virtual camera for each game space. For example, the camera placement control unit 113 may arrange the virtual camera at a certain direction, distance, and angle from the object so that the object appears in the center of the field-of-view region in a specific direction based on the position and direction of a specific object. The specific object may be, for example, an object of an operating character on the user terminal 100, a dynamic object indicating another character such as a non-player character, or a static object indicating a building, a tree, a stone, or the like. Here, the dynamic object in the game space includes a character (for example, a non-player character, an enemy character, and the like) that operates based on the game programs 121 and 221 and an operating character that operates based on an operation by the user.

The display control unit 114 causes the display unit 152 to display an image. For example, the display control unit 114 generates an image in which the field-of-view region of the virtual camera defined by the camera arrangement control unit 113 in the game space and an object existing in the region are drawn and causes the display unit 152 to display the image. The display control unit 114 may draw an object related to a user interface (UI) necessary for various operations of the game, such as an icon, a button, and a menu showing various parameters, so as to be superimposed on such an image.

The object control unit 115 arranges the object in the game space based on the setting information of the object included in the game information 122. The object control unit 115 controls the objects arranged in the game space. For example, the object control unit 115 changes the position, direction, shape, color, and the like of the object in the game space, and causes the object to perform a predetermined series of operations.

The game system 1 may be configured so that the server 200 has at least a part of the functions provided by the user terminal 100. The game system 1 may be configured so that the user terminal 100 has at least a part of the functions provided by the server 200. Further, devices other than the user terminal 100 and the server 200 may be used as components of the game system 1, and the hardware may execute a part of the processing in the game system 1. That is, the computer that executes the game programs 121 and 221 in the present embodiment may be any one of the user terminal 100, the server 200, and other devices.

<Overview of Game>

(Game Space and Arrangement of Objects and Virtual Camera)

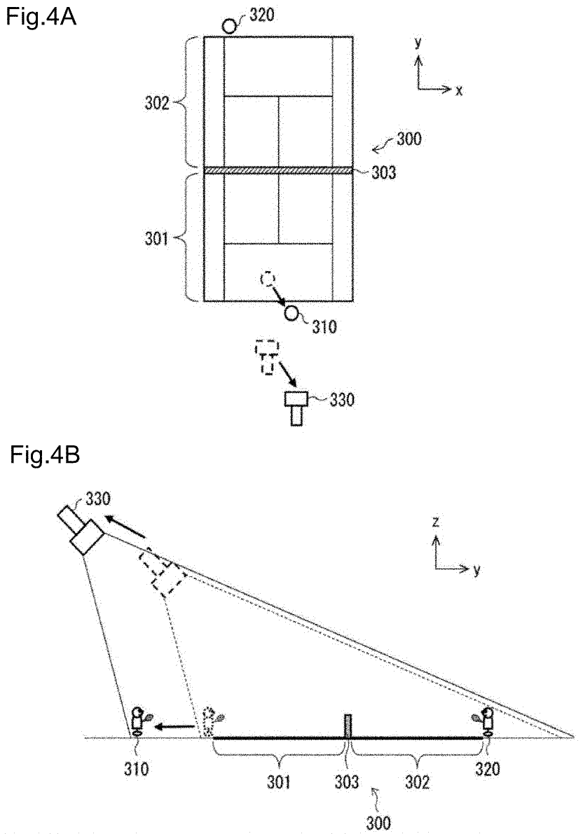

FIG. 4 is a diagram showing an example of a match space, which is a kind of game space in a tennis game. A match of a tennis game progresses in a three-dimensional match space having three axes of X-axis, Y-axis, and Z-axis as coordinate axes. The state of FIG. 4A shows an arrangement example of various objects and the virtual camera 330 when the match space is viewed from a viewpoint parallel to the XY plane. The state of FIG. 4B shows an arrangement example of various objects and the virtual camera 330 when the match space is viewed from a viewpoint parallel to the ZY plane. In the following description, when referring to an object once described with a reference numeral again, the word “object” is omitted as much as possible. For example, when the “operating character object 310” is referred to again, it is simply referred to as the “operating character 310”.

The object control unit 115 arranges a substantially planar object 300 indicating a tennis court substantially parallel to the XY plane of the match space. The object control unit 115 arranges an object 303 indicating a net so as to divide the tennis court 300 into two in the longitudinal direction. The object control unit 115 arranges the object (first object) 310 of an operating character operated by the subject user and the object (other object) 320 of an opponent character operated by another user who is an opponent in the tennis court 300. For example, the object control unit 115 arranges the operating character 310 in the court 301 and its peripheral region (first region). The object control unit 115 arranges the opponent character 320 in the court 302 and its peripheral region (second region). In other words, the first region is the region where the operating character 310 can move, and the second region is the region where the opponent character 320 can move. The peripheral regions of court 301 and court 302 are predetermined regions, for example, outside the baseline and outside the sidelines of the respective courts.

The camera arrangement control unit 113 arranges the virtual camera 330 in the game space. The position and angle of the virtual camera 330 are not particularly limited. For example, the camera arrangement control unit 113 arranges the virtual camera 330 at a position and an angle at which the entire tennis court 300 and all characters are captured.

In the opponent user terminal 100, the character operated by the opponent is the operating character 310, while the character operated by the subject user is the opponent character 320, and the tennis game of the present embodiment is executed by the user terminal 100 of the opponent.

(Basic Operation During Match)

In a tennis game, one game consists of a plurality of points, similar to an actual tennis match.

One point starts from the serve of the operating character 310 or the opponent character 320. The operating character 310 and the opponent character 320 alternately hit a ball object (second object) 340 toward the opponent's court, and if any of the characters fails to return the ball, a score is given to the opponent.

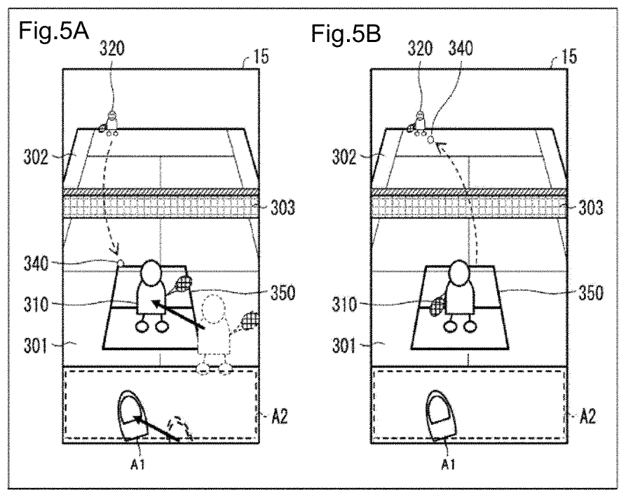

FIG. 5 shows some of the objects on the display screen displayed on the touch screen 15 during a match in a tennis game. Further, FIG. 5 schematically shows an input operation performed by the user on the touch screen 15. As a game screen, the touch screen 15 displays an image including, for example, the entire tennis court 300, the operating character 310, and the opponent character 320. When a predetermined input operation is performed on the touch screen 15, the object control unit 115 causes the operating character 310 to perform various operations such as an operation of moving a serve start position, a toss operation, a serve operation, and a moving operation, a hitting operation, and the like during the rally in which the operating character 310 and the opponent character 320 alternately hit the ball 340 according to the progress of the game. Hereinafter, various operations of the operating character 310 during the rally will be described by taking the operating character 310 as an example.

The history of touch operations on the touch screen 15 is managed by a history information table (not shown). The position of the touch operation, the operation mode (tap operation, long tap operation, flick operation, drag operation, and the like) and the like are identified based on the history information table. Here, the tap operation is to perform a release operation at the position where an approach operation is performed after the user performs the approach operation to bring the finger or the like closer to the touch screen 15. The long tap operation is an operation in which the user keeps pressing the touch screen 15. The flick operation is a series of operations in which the user performs a release operation by moving the position where the approach operation is performed in a short time while maintaining the approach operation on the touch screen 15. The drag operation is an operation in which the user slides the finger or the like while maintaining the state in which the finger or the like is brought close to the touch screen 15.

A pointer for performing an input operation on the touch screen 15 is not particularly limited. For example, the pointer may be a user's finger, a stylus pen, or the like. In the present embodiment, the user's finger (finger A1) is used as the pointer. In the present embodiment, it is assumed that the input operation receiving unit 112 receives the input operation performed at any position on the touch screen 15 unless otherwise specified.

FIG. 5 shows a user's input operation and an operation of the operating character 310 during the rally. The rally starts when the operating character 310 or the opponent character 320 serves the ball 340, and ends when the operating character 310 or the opponent character 320 fails to return the ball (for example, the ball 340 cannot be returned, the returned ball 340 nets or is out of the court).

The state of FIG. 5A shows a situation in which the object control unit 115 moves the operating character 310 in response to a user's input operation. When the input operation receiving unit 112 receives a drag operation (an operation of sliding the finger A1 in the drawing in the arrow direction) after the serve of the operating character 310 or the opponent character 320, the game progress processing unit 111 specifies the drag operation as an instruction to move the operating character 310. The game progress processing unit 111 specifies the moving direction and the moving speed from the drag operation. The object control unit 115 moves the operating character 310 according to the content specified by the game progress processing unit 111 (see the arrow shown in the vicinity of the operating character 310 in the drawing).

During the rally, the camera arrangement control unit 113 determines the position and angle of the virtual camera 330 so that the operating character 310 is displayed with a predetermined region A2 from the front side of the touch screen 15 toward the center of the screen when viewed from the user. In this way, it is possible to prevent the tennis court 300, the opponent character 320, the operating character 310, the ball 340, and the like from being hidden by the finger Al of the user who performs the input operation. Therefore, the user can easily perform the input operation while observing the situation of the game.

The camera arrangement control unit 113 arranges the virtual camera 330 at a position and an angle so that the court 301 and the court 302 can be seen in the vertical direction (direction parallel to the y-axis in FIG. 4). In this way, it is possible to show the user the operating character 310 that hits the serve, the court on the opponent character 320 side that is the hit destination of the ball 340, and the trajectory of the served ball 340 with good visibility.

The state of FIG. 5B shows a situation in which the object control unit 115 causes the operating character 310 to perform a hitting operation (operation in which the operating character 310 swings a racket) in response to a user's input operation. When the input operation receiving unit 112 receives a touch operation during the rally, the game progress processing unit 111 specifies the touch operation as an instruction to cause the operating character 310 to perform a hitting operation. The object control unit 115 causes the operating character 310 to perform a hitting operation according to the instruction. That is, the object control unit 115 causes the operating character 310 to swing the racket and moves the ball 340 to the second region.

(Hitting Area)

When the operating character 310 is made to perform a hitting operation, the game progress processing unit 111 determines whether the ball 340 could be hit by the hitting operation (determination of hit success/failure). The object control unit 115 arranges a hitting area 350, which is a reference for determination of hit success/failure, in the game space together with the operating character 310. The hitting area 350 may differ in at least one of its size and shape depending on the type of operating character. The game progress processing unit 111 determines that the hitting was successful when the ball 340 is located in the hitting area 350 during the hitting operation, and determines that the hitting was not successful when the ball 340 is located outside the hitting area 350 during the hitting operation.

When it is determined that the hitting is successful, the game progress processing unit 111 further determines the degree of goodness of the positional relationship between the operating character 310 and the ball 340 according to the region of the hitting area 350 where the ball 340 is located and instructs the object control unit 115 to return the ball. For example, if the conditions other than the positional relationship are the same, the operating character 310 can return the ball the strongest when the positional relationship is the best. The “return” referred to herein means a return, that is, a normal shot, excluding the charge shot and the special shot described later.

As described above, the game progress processing unit 111 determines the hit success/failure and the ball strength during the hit according to the degree of goodness of the positional relationship between the hitting area 350 and the ball 340 during the hitting operation, that is, the degree of goodness of the positional relationship between the operating character 310 and the ball 340. For example, the game progress processing unit 111 determines the degree of goodness of the positional relationship according to at least one of the direction from the operating character 310 to the ball 340 and the distance from the operating character 310 to the ball 340.

In this way, it is possible to encourage the user to imagine the course of the ball 340 flying from the court on the opponent character 320 side and to move (position) the operating character 310 to a better position for hitting. Imagining the course and positioning before hitting are also important factors in a real tennis game. Therefore, the game system 1 can realize a match with an actual tennis strategy in a tennis game, and can improve the fun of the game.

(UI Layout)

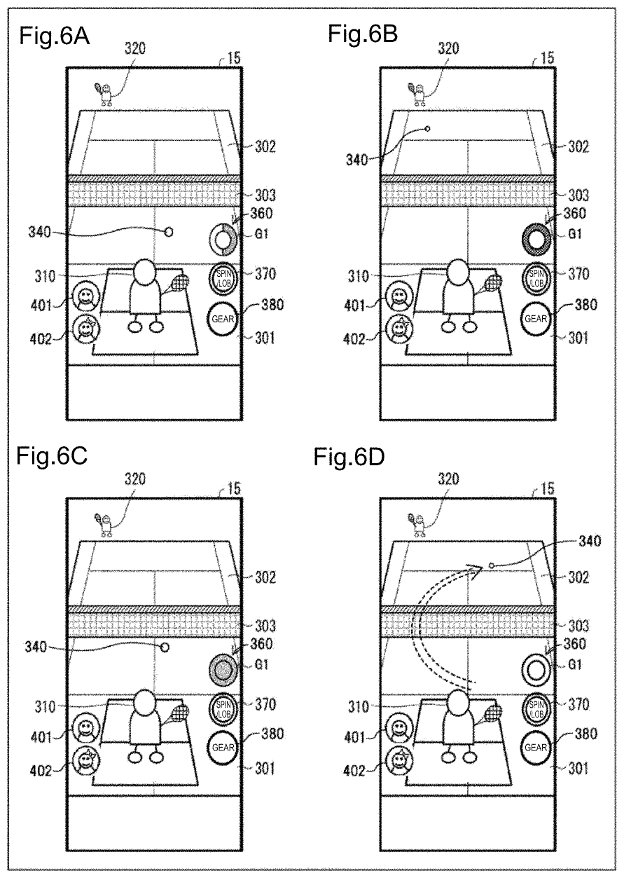

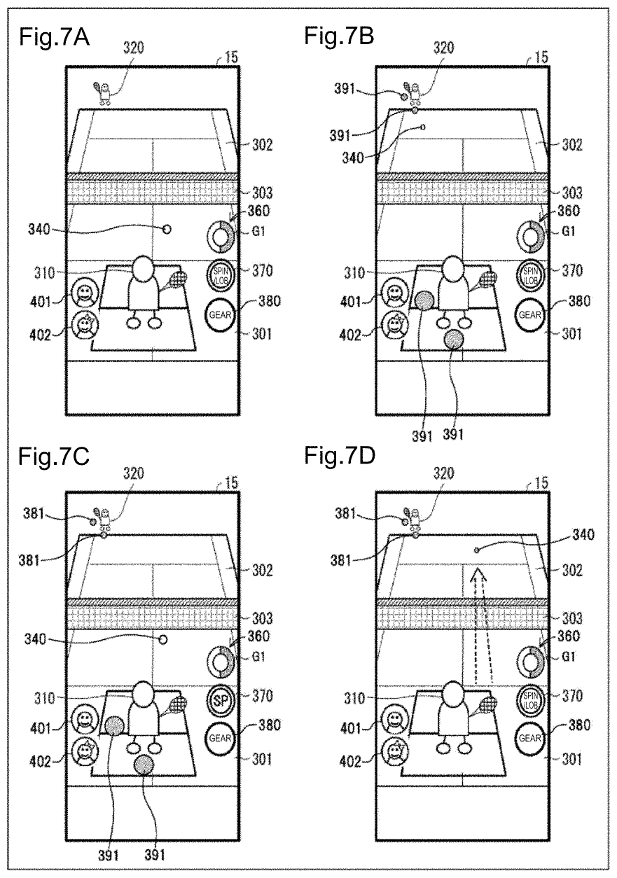

The display control unit 114 can display the UI image related to the user's input operation so as to be superimposed on the display screen shown in FIGS. 5A and 5B. FIGS. 6A to 6D and 7A to 7D are diagrams showing an example of a display screen during a rally displayed on the touch screen 15 by the display control unit 114. The display control unit 114 may create an image in which the images of a super shot button (second icon) 360, a shot type selection button (first icon) 370, and change buttons 401 and 402 are superimposed on the image depicting the objects in the game space and display the image on the touch screen 15. The UI image may be superimposed on the court and always displayed not only during the rally but also during the match.

In the present embodiment, the type of shot performed by the operating character 310 can be selected by a touch operation on a button icon. Normal shots and skill shots are provided as the types of the shots.

The normal shots include spin-type shots, lob-type shots, and slice-type shots. The spin-type shot is a shot in which the ball 340 is rotated forward in the vertical direction and returned toward the opponent character 320. The lob-type shot is a shot in which a high and loose ball is returned in a mountain so as to fall behind the opponent character 320. The slice-type shot is a shot in which the ball 340 is rotated backward in the vertical direction and returned toward the opponent character 320.

The type of normal shot is selected from spin/lob and slice by performing a touch operation on the shot type selection button 370. After that, when a touch operation for a hitting operation is performed, the selected type of normal shot is performed. The shot type selected by the touch operation on the shot type selection button 370 is maintained thereafter, and the normal shot of the selected shot type is performed by performing the touch operation.

On the other hand, a skill shot is a shot performed in association with the activation of a skill associated in advance according to the type of the character selected as the operating character 310 from the plurality of types of characters. The skill has a predetermined activation permission condition for permitting the activation of the skill. When the activation permission condition for the skill associated with the selected character is satisfied, and a touch operation is performed on a button icon corresponding to the skill, a standby state in which a skill shot associated with the skill activation can be performed is created. The skill shot can be performed by a touch operation for a hitting operation in the standby state in the same manner as the normal shot. Skill shots are shots of which the degree of advantage for the user is higher than normal shots. A shot with a high degree of advantage means, for example, a shot in which the speed of the returned ball is high, or a shot in which it is difficult for the opponent to return the ball because the ball is heavy.

As the skill shot, for example, a charge shot (first skill), a super shot (second skill), and a gear shot (third skill) are provided according to the type of the character. In the present embodiment, super shots and gear shots are also referred to as “special shots”.

The super shot among the special shots is, for example, a skill shot that enters a special shot standby state (second standby state, strictly speaking, a special shot standby state corresponding to a super shot) when a touch operation (fifth touch operation) on the super shot button 360 is received in a state (second state) in which an activation permission condition (first condition) associated with the super shot is satisfied. The activation permission condition associated with the super shot is satisfied, for example, when the value of a super shot gauge G1 updated according to the progress of the rally (number of returns, or the like) reaches a predetermined value. The super shot is activated when a tap operation (sixth touch operation) for a hitting operation is received from the user in the special shot standby state.

When the super shot is activated, the ball 340 is returned in a manner advantageous to the operating character 310. For example, the ball 340 moves to the court on the opponent character 320 side in a special trajectory that does not occur during a normal shot.

The gear shot among the special shots is, for example, a skill shot that enters a special shot standby state (third standby state, strictly speaking, a special shot standby state corresponding to a gear shot) when a touch operation (seventh touch operation) on the gear shot button 380 is received in a state (third state) in which an activation permission condition (second condition) associated with the gear shot is satisfied. The activation permission condition associated with the gear shot is satisfied, for example, when the number of activations in one match does not reach a predetermined upper limit number of times (for example, three times). The gear shot is activated when a tap operation (eighth touch operation) for a hitting operation is received from the user in the special shot standby state.

When the gear shot is activated, the movement of the returned ball 340 changes in an advantageous manner for the operating character 310. For example, the ball 340 makes an irregular bounce when it lands on the court on the opponent character 320 side.

The charge shot is, for example, a skill shot that enters a charge shot standby state (first standby state) when a touch operation (second touch operation) on the shot type selection button 370 for selecting the type of a normal shot is received in a state (first state) in which an activation permission condition associated with the charge shot is satisfied. The activation permission condition associated with the charge shot is satisfied, for example, when a charge level reaches level 1 or higher according to the value of the charge shot gauge (first parameter) updated while the touch operation (first touch operation) is continued during the match play. In addition, when a touch operation on the shot type selection button 370 is received in a state in which the activation permission condition associated with the charge shot is satisfied, a charge shot can be selected as one of the shot types, and a charge shot standby state is created when the charge shot is selected. The charge shot is activated when a tap operation (third touch operation) for a hitting operation is received from the user in the charge shot standby state.

When the charge shot is activated, the ball 340 is returned in a manner advantageous to the operating character 310. For example, the ball 340 moves to the court on the opponent character 320 side at a ball speed that cannot occur during a normal shot.

If the charge shot is activated in response to one tap operation after the charge level reaches level 1 or higher, since there is a possibility that the charge shot is activated by an erroneous tap operation or an operation for moving the operating character 310, the charge shot cannot be activated at the timing desired by the user. Therefore, in the present embodiment, the charge shot standby state can be set by a tap operation on an existing button such as the shot type selection button 370, and the charge shot is activated when a tap operation for a hitting operation is received in the charge shot standby state. In this way, in a situation in which the super shot button 360, the gear shot button 380, and the shot type selection button 370 are already arranged, the charge shot can be activated at the time desired by the user without adding new buttons (that is, without complicating the screen).

When the rally ends without activation of the charge shot, the game progress processing unit 111 initializes the charge shot gauge and maintains the charge level at the end of the rally. Therefore, if the charge level at the end of the rally is level 0, the gauge value of the charge shot gauge is returned to 0, and the charge level of level 0 is maintained. If the charge level at the end of the rally is level 1, the gauge value of the charge shot gauge is returned to 0, and the charge level of level 1 is maintained.

When the next rally is started, the game progress processing unit 111 updates the gauge value and the charge level starting from the initialized charge shot gauge and the maintained charge level. Therefore, if the charge level of level 1 is maintained, the charge level will be updated from level 1 to level 2 when the gauge value of the charge shot gauge reaches a threshold value in the next rally.

(Super Shot Button)

With reference to FIG. 6A, the super shot button 360 is a button for receiving an input operation for causing the operating character 310 to make a super shot. A super shot gauge G1 is provided on the outer edge of the super shot button 360. The game progress processing unit 111 increases the gauge value of the super shot gauge G1 according to the progress of the rally. Specifically, the game progress processing unit 111 increases the gauge value of the super shot gauge G1 each time a normal shot is activated in response to a tap operation or a flick operation for a hitting operation. Here, the amount of increase in the gauge value is increased as the degree of goodness of the positional relationship between the operating character 310 and the ball 340 at the time of a normal shot increases. The display control unit 114 changes the display mode of the super shot gauge G1 to a display mode in which the gauge value after the increase can be specified (see FIG. 6B).

The input operation receiving unit 112 enables the tap operation on the super shot button 360 to be received when the gauge value reaches a maximum value (the state shown in FIG. 6B). The game progress processing unit 111 sets a special shot standby state corresponding to the super shot when the tap operation is received by the input operation receiving unit 112. The display control unit 114 changes the display mode of the super shot button 360 to a display mode capable of specifying that the super shot can be activated. For example, the brightness of the super shot button 360 is reduced (see FIG. 6C).

The game progress processing unit 111 instructs the object control unit 115 to activate the super shot when it is determined that the hitting operation of the operating character 310 was successful in the special shot standby state corresponding to the super shot. As a result, the ball 340 is returned in a special trajectory that does not occur during a normal shot (see FIG. 6D).

After the super shot is activated, the game progress processing unit 111 cancels the special shot standby state corresponding to the super shot and initializes the super shot gauge G1. The display control unit 114 restores the brightness of the super shot button 360, and changes the display mode to a display mode capable of specifying that the display mode of the super shot gauge G1 is initialized.

If the rally ends without activation of the super shot, the game progress processing unit 111 maintains the gauge value of the super shot gauge G1 at the end of the rally. When the next rally is started, the game progress processing unit 111 increases the gauge value each time a normal shot is performed, starting from the maintained gauge value.

(Gear Shot Button)

The gear shot button 380 is a button for receiving an input operation for causing the operating character 310 to make a gear shot. For gear shots, the upper limit number of times that the gear shot can be activated in one match is set in advance. The number of activation times of the gear shot is set to the upper limit number of times at the start of the match, and is decremented by 1 each time the gear shot is activated. If the number of activation times is 1 or more, the input operation receiving unit 112 allows reception of the tap operation on the gear shot button 380. The game progress processing unit 111 sets a special shot standby state corresponding to the gear shot when the tap operation is received by the input operation receiving unit 112.

The display control unit 114 changes the display mode of the gear shot button 380 to a display mode capable of specifying that the gear shot can be activated. For example, the brightness of the gear shot button 380 is reduced. When the game progress processing unit 111 determines that the hitting operation of the operating character 310 was successful in the special shot standby state corresponding to the gear shot, the game progress processing unit 111 instructs the object control unit 115 to activate the gear shot. As a result, the ball 340 makes an irregular bounce when it lands on the court on the opponent character 320 side.

After the gear shot is activated, the game progress processing unit 111 cancels the special shot standby state corresponding to the gear shot, and reduces the number of activation times of the gear shot by one. The display control unit 114 restores the display mode of the gear shot button 380.

(Shot Type Selection Button)

The shot type selection button 370 is a button for indicating the type of normal shot executed by the hitting operation of the operating character 310 and receiving an input operation for changing the type. When the tap operation on the shot type selection button 370 is received by the input operation receiving unit 112, the game progress processing unit 111 changes the type of the normal shot performed by the operating character 310 between spin/lob and slice. The display control unit 114 changes the display mode of the shot type selection button 370 to a display mode capable of specifying the changed type. For example, the character “spin/lob” is displayed on the shot type selection button 370 if the changed type is spin/lob, and the character “slice” is displayed on the shot type selection button 370 if the changed type is slice. The object control unit 115 moves the ball 340 to the court on the opponent character 320 side according to the changed type and the mode of the touch operation for the hitting operation.

Specifically, when a tap operation (fourth touch operation) is performed for the hitting operation in a state in which spin/lob is selected as the changed type of the normal shot, the object control unit 115 specifies the return direction based on the position of the ball 340 at the time of the tap operation and causes the operating character 310 to perform an action of returning the ball 340 that rotates forward in the vertical direction in the return direction. Further, when a right flick operation (an operation of flicking to the right, which corresponds to a fourth touch operation) is performed for the hitting operation in a state in which the spin/lob is selected, the object control unit 115 causes the operating character 310 to perform an action of returning the ball 340, which rotates forward in the vertical direction, in the direction to the right of the return direction at the time of the tap operation.

Further, when a left flick operation (the operation of flicking to the left, which corresponds to the fourth touch operation) is performed for the hitting operation in a state in which the spin/lob is selected, the object control unit 115 causes the operating character 310 to perform an action of returning the ball 340, which rotates forward in the vertical direction, in the direction to the left of the return direction at the time of the tap operation. Further, when a down flick operation (an operation of flicking downward, which corresponds to the fourth touch operation) is performed for the hitting operation in a state in which the spin/lob is selected, the object control unit 115 causes the operating character 310 to perform an action of returning the ball 340 in a lob in the return direction when the tap operation was performed.

In the state in which the slice is selected as the changed type of the normal shot, the object control unit 115 specifies the return direction based on the position of the ball 340 at the time of the touch operation (fourth touch operation) for the hitting operation. The object control unit 115 causes the operating character 310 to perform an action of returning the ball 340, which rotates backward in the vertical direction, in the return direction. The return ball accompanied by the slice is executed regardless of whether the touch operation for the hitting operation is a tap operation or a flick operation. In this way, it is possible to prevent the operation when performing a slice-type shot from becoming complicated as much as possible.

(Charge Shot: First Game Control)

With reference to FIG. 7A, when the input operation receiving unit 112 receives a drag operation or a long tap operation (first touch operation) after the serve of the operating character 310 or the opponent character 320 (after the start of the rally), the game progress processing unit 111 increases the gauge value of the charge shot gauge provided internally. However, the amount of increase per unit time when the drag operation is received is smaller than that when the long tap operation is received. That is, when the operating character 310 is moved by the drag operation, the gauge value is increased so that the amount of increase in the gauge value is smaller than that when the operating character 310 is not moved by the long tap operation. For example, the amount of increase corresponding to the drag operation is 0.8 times the amount of increase corresponding to the long tap operation.

When the input operation receiving unit 112 receives a long tap operation after the start of the rally, the game progress processing unit 111 does not specify the long tap operation as an instruction to move the operating character 310. At this time, the object control unit 115 keeps the operating character 310 at the current position.

When the input operation receiving unit 112 receives a drag operation in the charge shot standby state, the game progress processing unit 111 exerts an action disadvantageous to the user regarding the game progress. Specifically, if the charge shot standby state is set, a slower speed than that when the charge shot standby state is not set is determined as the moving speed of the operating character 310. For example, the moving speed when the charge shot standby state is set is 0.8 times the moving speed when the charge shot standby state is not set. The object control unit 115 moves the operating character 310 at the determined moving speed.

When the increased gauge value reaches the threshold value, the game progress processing unit 111 initializes the charge shot gauge and updates the charge level and the threshold value. As for the threshold value, different values are set according to the charge level, and the higher the charge level, the higher the threshold value. At the start of the match, the charge level is set to level 0 and the threshold is set to a first value. When the gauge value reaches the first value, the game progress processing unit 111 initializes the gauge value, updates the charge level to level 1, and updates the threshold value to a second value. When the gauge value reaches the second value, the gauge value is initialized, the charge level is updated to level 2, and the threshold value is updated to a third value. Further, when the gauge value reaches the third value, the gauge value is initialized and the charge level is updated to level 3. When the upper limit of the charge level is level 3, and level 3 is reached, the charge level and the threshold value are not updated. Further, for example, the second value is 1.2 times the first value, and the third value is 1.5 times the first value.

The display control unit 114 displays a level number object 391 for specifying the charge level in the vicinity of the operating character 310 (see FIG. 7B). That is, if the charge level is level 1, the level number object 391 is displayed at a position corresponding to the back of the operating character 310. If the charge level is level 2, as shown in FIG. 7B, the level number object 391 is displayed at a position corresponding to each of the back and the left side of the operating character 310. Further, if the charge level is level 3, the level number object 391 is displayed at a position corresponding to each of the back, left side, and right side of the operating character 310. The level number object 391 displayed in this way moves with the movement of the operating character 310. As a result, the user can easily recognize the charge level of the operating character 310.

If the charge level is in a state of level 1 or higher (first state), the game progress processing unit 111 can select a charge shot as a shot type when a tap operation on the shot type selection button 370 is received by the input operation receiving unit 112. That is, when the charge level is level 1 or higher, the charge shot standby state is set, the shot type of spin/lob is set, or the shot type of slice is set for each tap operation on the shot type selection button 370. More specifically, after the charge level has increased from level 0 to a value of level 1 or higher, the charge shot standby state is always set when the first tap operation is performed on the shot type selection button 370. After that, each time the tap operation is performed, the setting is changed in the order of spin/lob, slice, charge shot standby state, spin/lob, and the like. When the shot type of spin/lob or slice is set, the charge shot standby state is canceled.

The display control unit 114 shifts the display mode of the shot type selection button 370 to a display mode in which the setting can be specified. For example, when the charge shot standby state is set, the display mode of the shot type selection button 370 is changed to a first display mode indicating that the charge shot standby state is set. Specifically, the character “SP” is displayed on the shot type selection button 370 (see FIG. 7C). Further, when the shot type of spin/lob is set, the character “spin/lob” is displayed on the shot type selection button 370 (see FIG. 7B). Further, when the shot type of slice is set, the character “slice” is displayed on the shot type selection button 370.

In a state in which the charge level is level 0, even if a touch operation on the shot type selection button 370 is performed, the display control unit 114 does not receive the touch operation as a second touch operation and does not shift the display mode of the shot type selection button 370 to a first display mode.

In the charge shot standby state, when the input operation receiving unit 112 receives a tap operation (third touch operation) and the ball 340 is located in the hitting area 350, the game progress processing unit 111 determines that the hitting operation of the operating character 310 was successful, and instructs the object control unit 115 to activate a charge shot. A charge shot is one of the skills to return the ball 340 in a manner advantageous to the operating character 310 during the rally, and specifically, is a shot that exerts a specific action on the operating character 310 or the opponent character 320. The game progress processing unit 111 activates the charge shot in such a manner that the higher the level representing the charge level, the higher the degree of advantage for the user. That is, the degree of advantage of the charge shot differs depending on the charge level, and the higher the charge level, the higher the degree of advantage.

The mode in which the degree of advantage is high is, for example, a mode in which the ball 340 is moved to the court on the opponent character 320 side at a special moving speed or rotation speed (see FIG. 7D). The special moving speed is, for example, a moving speed that does not occur during a normal shot, and the special rotation speed is, for example, a rotation speed that does not occur during a normal shot. The special moving speed or rotation speed increases with an increase in the level representing the charge level.

After the charge shot is activated, the game progress processing unit 111 cancels the charge shot standby state and initializes the charge shot gauge and the charge level. The display control unit 114 does not display the level number object 391 and restores the display mode of the shot type selection button 370 to the display mode before the charge shot standby state is set. If the rally ends without activation of the charge shot, the game progress processing unit 111 initializes only the charge shot gauge among the charge shot gauge and the charge level.

That is, the gauge value of the charge shot gauge is cumulatively updated by a long tap or the like during one rally, and is initialized when the rally ends. On the other hand, the charge level is maintained even if one rally ends and is carried over to the subsequent rallies.

The game progress processing unit 111 transmits charge level information for specifying the charge level of the operating character 310 to the opponent user terminal 100 via the server 200, and receives charge level information for specifying the charge level of the opponent character 320 from the opponent user terminal 100 via the server 200. The display control unit 114 displays the level number object 391 in the vicinity of the opponent character 320 based on the received charge level information (see FIGS. 7B to 7D). The charge level of the opponent character 320 is notified by the display of the level number object 391.

Specifically, if the charge level is level 1, the level number object 391 is displayed at a position corresponding to the front of the opponent character 320. If the charge level is level 2, the level number object 391 is displayed at a position corresponding to each of the front and the right side of the opponent character 320. Further, if the charge level is level 3, the level number object 391 is displayed at a position corresponding to each of the front, the right side, and the left side of the opponent character 320.

In the charge shot standby state, an effect that is disadvantageous to the user regarding the progress of the game is exerted. Specifically, the moving speed of the operating character 310 in response to the drag operation is slower than that when it is not in the charge shot standby state. The disadvantageous effect is not exerted in response to the charge level becoming level 1 or higher, but is exerted in response to the charge shot standby state being set. Since the charge shot is activated by the user when a chance occurs during the rally, it is possible to improve the fun of the game by giving a disadvantage to the user in the situation in which the chance occurs.

(Change Button)

The change buttons 401 and 402 are buttons for receiving an input operation for changing the operating character 310 with a reserved character associated with each of the change buttons 401 and 402, respectively. The display control unit 114 may display a number of change buttons corresponding to the number of reserved characters. However, if the number of change buttons displayed by the display control unit 114 increases, the area for displaying the match of the tennis game becomes narrow. Therefore, an upper limit (for example, two people) may be set for the number of other characters that can belong to the same group as the operating character, or an upper limit (for example, two) may be set for the number of change buttons to be displayed. When the number of change buttons to be displayed is smaller than the number of reserved characters, the display control unit 114 may determine the reserved characters associated with the change buttons according to the priority set in advance by the user.

The game progress processing unit 111 receives a change instruction by the user. The change instruction is input by a touch operation on the change button 401 or 402. For example, when a touch operation on the change button 401 is detected, the game progress processing unit 111 instructs the object control unit 115 such that a character associated with the change button 401 is selected and the operating character 310 is changed to the selected character. The object control unit 115 arranges (displays) the selected character in place of the operating character 310. The character that has become a reserved character from the operating character 310 by the change instruction may be associated with the change button 401. In this case, when a touch operation on the change button 401 is detected again, it is possible to return to the operating character 310.

<Processing Flow of User Terminal>

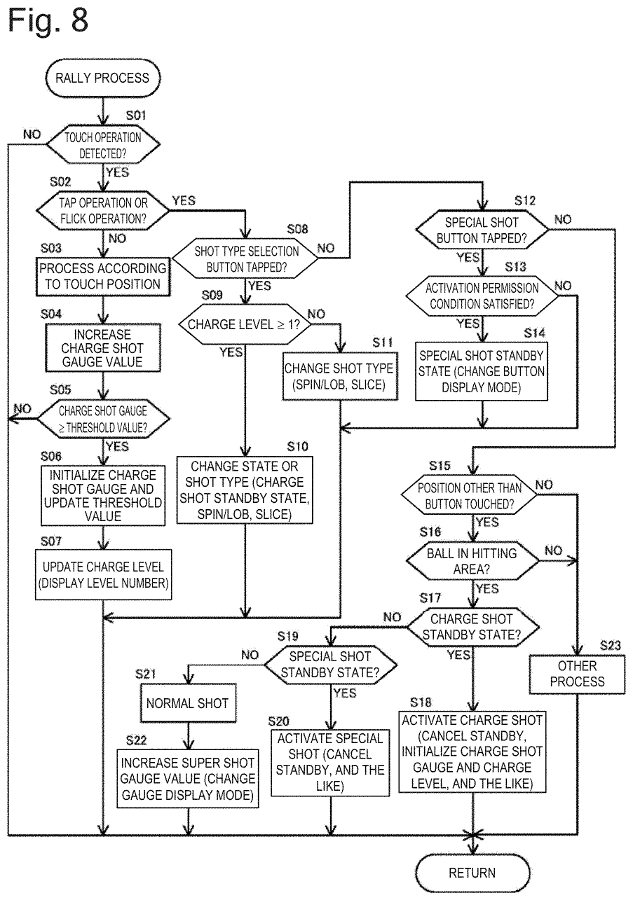

FIG. 8 is a flowchart illustrating the processing executed during the rally. This process is executed by the game progress processing unit 111, the input operation receiving unit 112, the display control unit 114, and the like. In the following description, the flow of a series of processing steps described using the flowchart is described as being executed by the user terminal 100, but at least a part of these processing steps may be executed by the server 200.

In step S01, it is determined whether the touch operation on the touch screen 15 is performed based on the input operation on the input unit 151. If it is not determined that the touch operation is being performed, the process returns to the starting step, whereas if it is determined that the touch operation is being performed, the process proceeds to step S02. In step S02, it is determined whether the touch operation is a tap operation or a flick operation based on the history information table. If it is not determined that the touch operation is the tap operation or the flick operation, the process proceeds to step S03, and the process according to the touch position is executed.

Specifically, if the touch operation is a drag operation, the moving direction and the moving speed are specified from the drag operation, and the operating character 310 is moved according to the specified contents. For the moving speed, a different speed is specified depending on whether the charge shot standby state is set. For example, if the charge shot standby state is not set, the speed H is specified, whereas if the charge shot standby state is set, the speed L slower than the speed H is specified. If the touch operation is a long tap operation, the operating character 310 is kept at the current position.

In step S04, the gauge value of the charge shot gauge is increased. The amount of increase per unit time when a drag operation is received is smaller than that when a long tap operation is received. In step 505, it is determined whether the increased gauge value is equal to or greater than a predetermined value based on the processing result of step S04. If it is not determined that the value is equal to or greater than the predetermined value, the process returns to the starting step. On the other hand, when it is determined that the value is equal to or greater than the predetermined value, the charge shot gauge is initialized in step S06 and the predetermined value is updated.

That is, the predetermined value is set to a first threshold value at the start of the rally. When the gauge value reaches the first threshold value, the gauge value is initialized and the predetermined value is updated to a second threshold value. Further, when the gauge value reaches the second threshold value, the gauge value is initialized and the predetermined value is updated to a third threshold value. When the process of step S06 is completed, the process proceeds to step S07.

In step S07, the charge level is updated with level 3 as the upper limit. Specifically, if the current charge level is level 0, it is updated to level 1, whereas if the current charge level is level 1, it is updated to level 2. If the current charge level is level 2, it is updated to level 3, whereas if the current charge level is level 3, the level 3 is maintained. In step S07, the level number object 391 corresponding to the charge level is displayed in the vicinity of the operating character 310. When the process of step S07 is completed, the process returns to the starting step.

If it is determined in step S02 that the operation is a tap operation or a flick operation, the process proceeds to step S08. In step S08, it is determined whether the shot type selection button 370 has been tapped based on the history information table. When it is determined that the shot type selection button 370 has been tapped, the process proceeds to step S09, and it is determined whether the current charge level is level 1 or higher based on the processing result of step S07.

If it is not determined that the level is 1 or higher, the process proceeds to step S11, and the shot type of the ball hit by the operating character 310 is changed between spin/lob and slice. In step S11, the display mode of the shot type selection button 370 is changed to a display mode in which the changed shot type can be specified. For example, if the changed shot type is spin/lob, the character “spin/lob” is displayed on the shot type selection button 370, whereas if the changed shot type is a slice, the character “slice” is displayed on the shot type selection button 370.

On the other hand, when it is determined in step S09 that the level is 1 or higher, the process proceeds to step S10, and the charge shot standby state is set, the shot type of spin/lob is set, or the shot type of slice is set. That is, when the tap operation on the shot type selection button 370 is the first tap operation after the charge level has increased from level 0 to a value of level 1 or higher, the charge shot standby state is always set. That is, at the first tap after the gauge value of the charge shot gauge reaches the first threshold value, the charge shot standby state is always created. After that, each time the tap operation is performed, the setting is changed in the order of spin/lob, slice, charge shot standby state, spin/lob, and the like. When the shot type of spin/lob or slice is set, the charge shot standby state is canceled.

In step S10, the display mode of the shot type selection button 370 is changed to a display mode in which the setting can be specified. For example, if the setting is the charge shot standby state, the character “SP” is displayed on the shot type selection button 370. If the setting is the shot type of spin/lob, the character “spin/lob” is displayed on the shot type selection button 370. Further, if the setting is the shot type of slice, the character “slice” is displayed on the shot type selection button 370.

If it is not determined that the shot type selection button 370 has been tapped in step S08, the process proceeds to step S12. In step S12, it is determined whether the special shot button, that is, the super shot button 360 or the gear shot button 380 is tapped, based on the history information table. When it is determined that the super shot button 360 or the gear shot button 380 has been tapped, the process proceeds to step S13.

When the process proceeds to step S13 in response to the tap operation on the super shot button 360, it is determined in step S13 whether the activation permission condition associated with the super shot button 360 is satisfied. On the other hand, when the process proceeds to step S13 in response to the tap operation on the gear shot button 380, it is determined in step S13 whether the activation permission condition associated with the gear shot button 380 is satisfied.

The activation permission condition associated with the super shot button 360 is a condition that is satisfied when the gauge value of the super shot gauge G1 reaches the maximum value, and whether the condition is satisfied is determined based on the processing result of step S22 described later. The activation permission condition associated with the gear shot button 380 is a condition that is satisfied when the number of activation times of the gear shot is 1 or more, and whether the condition is satisfied is determined based on the processing result of step S20 described later.

When it is determined in step S13 that the standby state is established, the process proceeds to step S14. In step S14, a special shot standby state is set for the tapped button among the super shot button 360 and the gear shot button 380, and the display mode of the tapped button is changed to a display mode indicating that a special shot is possible. For example, when the special shot standby state is set for the super shot button 360, the brightness of the super shot button 360 is reduced. Further, when the special shot standby state is set for the gear shot button 380, the brightness of the gear shot button 380 is reduced. When the process of step S14 is completed, the process returns to the starting step. If it is not determined in step S13 that the activation permission condition is satisfied, the process returns to the starting step without executing the process of step S14.

If it is not determined in step S12 that the super shot button 360 or the gear shot button 380 has been tapped, the process proceeds to step S15. In step S15, it is determined based on the history information table whether a touch operation has been performed on a position other than the super shot button 360, the shot type selection button 370, the gear shot button 380, and the change buttons 401 and 402. If it is not determined that the tap operation has been performed, another process (for example, a process of changing the operating character 310) is executed in step S23, and then the process returns to the starting step. On the other hand, when it is determined that the tap operation has been performed, the process proceeds to step S16.

In step S16, the current arrangement of the hitting area 350 is specified based on the current position of the operating character 310, and it is determined whether the ball 340 is located in the hitting area 350 based on the specific result. If it is not determined that the ball is located in the hitting area 350, another process (for example, a process of missing the ball) is executed in step S23, and then the process returns to the starting step. On the other hand, if it is determined that the ball is located within the hitting area 350, the process proceeds to step S17. In step S17, it is determined whether the current touch operation is a tap operation in the charge shot standby state based on the processing result of step S10 and the history information table.

When it is determined that the touch operation is the tap operation in the charge shot standby state, the process proceeds to step S18 to activate the charge shot. In step S18, the charge shot standby state is canceled, and the charge shot gauge and the charge level are initialized. The level number object 391 is not displayed, and the display mode of the shot type selection button 370 is restored to the display mode before the charge shot standby state was set. When the process of step S18 is completed, the process returns to the starting step.

If it is not determined in step S17 that the charge shot standby state is set, the process proceeds to step S19. In step S19, it is determined whether the current touch operation is a tap operation in the special shot standby state based on the processing result of step S10 and the history information table. When it is determined that the touch operation is the tap operation in the special shot standby state, the process proceeds to step S20 to activate the special shot. Specifically, when the special shot standby state is set for the super shot button 360, the super shot is activated, whereas when the gear shot button 380 is set for the special shot standby state, the gear shot is activated.

In step S20, the set special shot standby state is canceled. Further, when the super shot is activated, the super shot gauge G1 is initialized and the display mode of the super shot button 360 is restored. On the other hand, when the gear shot is activated, the number of activation times of the gear shot is reduced by 1, and the display mode of the gear shot button 380 is restored. When the process of step S20 is completed, the process returns to the starting step.

If it is not determined in step S19 that the special shot standby state is set, a normal shot is executed in step S21. When the process of step S21 is completed, the gauge value of the super shot gauge G1 is increased in step S22. The amount of increase in the gauge value increases as the degree of goodness of the positional relationship between the operating character 310 and the ball 340 increases. When the process of step S22 is completed, the process returns to the starting step.

<Effect of Present Embodiment>

According to the present embodiment, the gauge value of the charge shot gauge is updated while the first touch operation on the touch screen 15 is continued. The first game control is executed based on the fact that after the release of the first touch operation, the second touch operation is received from the user and then the third touch operation is further received.

That is, the first game control is executed when a plurality of touch operations such as a second touch operation and a third touch operation are received. As a result, it is possible to prevent as much as possible the inconvenience that the first game control is executed at a timing not intended by the user due to an erroneous operation after the first touch operation is released.

Further, according to the present embodiment, in the first state in which the value of the first parameter is updated to be equal to or greater than the first threshold value, when the second touch operation and the third touch operation are received, the first object 310 is caused to activate the first skill as a first game control.

That is, whether the first game control is executed depends on the duration of the first touch operation. The user needs to perform the first touch operation while checking the progress of the game, which makes it possible to improve the fun of the game. In addition, the first object 310 activates the first skill by the first game control. This allows the user to advance the game in an advantageous manner.

Further, according to the present embodiment, when the second touch operation is received in the first state, the first standby state in which the first skill can be activated is created. The first skill is activated when a third touch operation is received in the first standby state.

In this way, the meaning of each touch operation is clear such that the second touch operation is an operation for setting the first standby state, and the third touch operation is an operation for activating the first skill. As a result, it is possible to avoid the inconvenience that the user is confused by the touch operation as much as possible.

Further, according to the present embodiment, the second touch operation is a touch operation on the first icon 370 displayed on the touch screen 15. In the first state described above, when the touch operation on the first icon 370 is received as the second touch operation, the display mode of the first icon 370 is changed to a first display mode indicating that the first standby state is set. On the other hand, in the state in which the value of the first parameter is less than the first threshold value, even if the touch operation on the first icon 370 is performed, the touch operation is not received as the second touch operation, and the display mode of the first icon 370 is not changed to the first display mode.

That is, whether the display mode of the first icon 370 changes in response to the touch operation on the first icon 370 is different depending on whether the value of the first parameter is updated to the first threshold value or higher. The user can directly recognize from the display mode of the first icon 370 whether the first standby state is created by the touch operation.

Further, according to the present embodiment, the first icon 370 is an icon for selecting the type of an action to be performed by the first object 310 in response to a touch operation on the first icon 370. The first icon 370 is also an icon that makes it possible to select the type of an action corresponding to the first skill in the first state. The first standby state is a state in which the type of an action corresponding to the first skill is selected as the type of action. Further, on the touch screen 15, a second icon 360 different from the first icon 370 is displayed.

In a state different from the first standby state, in which another type of action different from the action corresponding to the first skill is selected according to the touch operation on the first icon 370, when a fourth touch operation is received, the action corresponding to the selected type is activated by the first object 310.

In the second state in which the first condition is satisfied, when the fifth touch operation on the second icon 360 is received, the second standby state in which the second skill different from the first skill can be activated by the first object 310 is set. When the sixth touch operation is received in the second standby state, the second skill is activated by the first object 310.

That is, the first icon is an icon for selecting the type of an action to be performed by the first object 310, and in the first state, it is also possible to select the type of an action corresponding to the first skill. In this way, it is possible to activate the first skill without increasing the number of icons (that is, without complicating the screen).

Further, when a fourth touch operation is received in a state in which another type of action different from the action corresponding to the first skill is selected according to the touch operation on the first icon 370, the other action is activated by the first object 310. On the other hand, when a fifth touch operation on the second icon 360 is received in the second state, the second standby state is set. When a sixth touch operation is received in the second standby state, a second skill different from the first skill is activated by the first object 310.

In this way, the first skill is activated by the same operation method as the operation method for activating the second skill. In this way, a beginner user can easily understand the operation method for activating the first skill.

In the present embodiment, the touch screen 15 displays a third icon 380, which is different from the first icon 370 and the second icon 360. When a seventh touch operation on the third icon 380 is received in the third state in which the second condition different from the first condition is satisfied, a third standby state in which a third skill different from the first skill and the second skill can be activated by the first object 310 is set. When an eighth touch operation is received in the third standby state, the third skill is activated by the first object.

That is, the first skill is activated by the same operation method as the operation method for activating the third skill. In this way, a beginner user can easily understand the operation method for activating the first skill.

In the present embodiment, in the first standby state, an action that is disadvantageous to the user regarding the progress of the game is exerted. Specifically, the moving speed of the first object 310 in response to the touch operation is slower than that when it is not in the first standby state.

The disadvantageous effect is not exerted in response to the value of the first parameter reaching the first threshold, but is exerted in response to the setting of the first standby state by the second touch operation. That is, the disadvantageous action is exerted when the user performs the second touch operation when the situation in which the first skill is desired to be activated is created. Therefore, the user is required to have strategy about the timing of performing the second touch operation. As a result, the fun of the game can be improved.

In the present embodiment, the first touch operation includes a touch operation for moving the first object 310. When the first touch operation is being performed and the first object 310 is being moved by the first touch operation, the value of the first parameter is updated so that the update amount of the value of the first parameter is smaller than when the first object 310 is not moved by the first touch operation.

Therefore, in order to increase the update amount of the value of the first parameter, it is necessary to perform a touch operation for not moving the first object 310 instead of the touch operation for moving the first object 310. The user is required to use the touch operation properly according to the match situation, which can improve the fun of the game.

In the present embodiment, even after the first touch operation is released, the value of the first parameter updated in response to the first touch operation is maintained. Therefore, the value of the first parameter is also increased when the first touch operation is performed with a touch operation different from the first touch operation performed therebetween. In this way, it is possible to gradually increase the value of the first parameter while watching the situation of the match, and to activate the first skill at a great chance.

In the present embodiment, the game progresses by operating the first object 310 that operates in response to the user's touch operation, and the end condition may be satisfied a plurality of times during one game. The value of the first parameter is updated according to the first touch operation until one end condition is satisfied, and the value of the first parameter is initialized when the value of the first parameter is not updated to the first threshold value when the one end condition is satisfied. On the other hand, when the value of the first parameter is updated to the first threshold value, the value corresponding to the first threshold value is maintained thereafter as the value of the first parameter. As a result, the user can be motivated to increase the value of the first parameter to the first threshold value or more by the time one end condition is satisfied.

In the present embodiment, the value of the first parameter is updated even after the value of the first parameter is updated to the first threshold value in response to the touch operation on the touch screen 15 until one end condition is satisfied. Further, when the value of the first parameter exceeds the first threshold value when the one end condition is satisfied, but is not updated to the second threshold value, the value exceeding the first threshold value is initialized and the value corresponding to the first threshold value is maintained thereafter as the value of the first parameter. When the value of the first parameter is updated to the second threshold value, the value corresponding to the second threshold value is maintained thereafter as the value of the first parameter.

Further, when the second touch operation and the third touch operation are received in the first state described above, a skill that is more advantageous to the user is activated as the first skill when the value of the first parameter is updated to the second threshold value than when the value of the first parameter exceeds the first threshold value but is not updated to the second threshold value.

In this way, even after the value of the first parameter reaches the first threshold value, the first touch operation can be continuously performed, and the user can be motivated to activate the skill having a higher degree of advantage.

In the present embodiment, another object 320 that competes with the first object 310 is operated by another user. Information corresponding to the value of the first parameter associated with the other user is notified based on the touch operation of the other user. In this way, it is possible to encourage users to advance the game strategically by activating the first skill to establish the end condition to prevent the value of the first parameter from being maintained in a situation in which the value of the first parameter of the other object 320 is likely to increase to the first threshold value.

In the present embodiment, the game progresses according to the positional relationship between the first object 310 that operates in response to the touch operation of the user and the second object 340 that is different from the first object 310. The condition for executing the first game control further includes that the third touch operation is received in a state in which the first object 310 and the second object 340 are in a predetermined positional relationship. In this way, it is possible to improve the fun of the game.

### MODIFIED EXAMPLE

Modified examples of the embodiments described above are listed below.

(1) In the above-described embodiment, when a drag operation or a long tap operation is once released during the rally and then the drag operation or the long tap operation is performed again, the gauge value is increased, starting from the gauge value of the charge shot gauge at the time of the release. However, the gauge value as the starting point may be increased or decreased from the gauge value at the time of the release according to the progress of the game. For example, the gauge value as the starting point may be increased or decreased according to the degree of goodness of the positional relationship between the hitting area 350 and the ball 340 at the time of the hitting operation after the release.

(2) In the above-described embodiment, the control for decreasing the moving speed of the operating character 310 is performed as a control that exerts an action disadvantageous to the user during the period in which the charge shot standby state is set. However, together with or instead of decreasing the moving speed, the amount of decrease in the stamina of the operating character 310 (a parameter capable of specifying the exercise ability of the character) may be increased, and the stamina of the opponent character 320 may be restored.

(3) In the above-described embodiment, the charge shot is activated based on the tap operation on the shot type selection button 370 and the tap operation for the hitting operation. However, regardless of whether the tap operation on the shot type selection button 370 is performed, the charge shot may be activated in response to the double tap operation for the hitting operation. In this case, the timing for receiving the double-tap operation may be any timing until the ball 340 returned by the opponent character 320 enters the hitting area 350.

(4) In the above-described embodiment, the charge level is updated based on the gauge value of the charge shot gauge, and the charge shot can be activated in a mode corresponding to the charge level after the update. However, when the tap operation on the shot type selection button 370 for setting the charge shot standby state and the tap operation on the super shot button 360 are continuously performed, the charge level may be updated based on the gauge value of the super shot gauge G1 at the time of the tap operation, and a charge shot that gives the user an advantage corresponding to the updated charge level may be activated.

(5) In the above-described embodiment, a situation may occur in which both the charge shot standby state and the special shot standby state are set. In this situation, the charge shot is activated in preference to the special shot. However, in such a situation, the special shot may be activated in preference to the charge shot. Moreover, a special shot that is stronger than either the charge shot or the special shot may be activated instead of the charge shot and the special shot.

(6) In the above-described embodiment, when the tap operation for activating the charge shot is performed, which is the tap operation for the hitting operation, the charge shot in the mode corresponding to the charge level is activated. However, the charge shot may be activated even when a flick operation for a hitting operation is performed. In this case, the degree of advantage for the user, of the charge shot corresponding to the flick operation may be higher than the degree of advantage of the charge shot corresponding to the tap operation.

(7) In the above-described embodiment, the degree of advantage to the user, of the charge shot is defined only by the charge level when the charge shot is activated. However, the degree of advantage may be defined by the charge level at the time of activating the charge shot and the gauge value of the charge shot gauge.

(8) In the above-described embodiment, the opponent character 320 is a character operated by another user who is an opponent. However, the opponent character 320 may be an NPC operated by a game program.

(9) In the above-described embodiment, if the charge level shows a value of level 1 or higher, the charge shot corresponding to the charge level can be activated until the end of the match. However, the time during which the charge shot can be activated may be limited to a predetermined time (for example, 20 seconds). That is, when a predetermined time elapses without activation of the charge shot in a situation in which the charge level is maintained at level 1 or higher after the charge level is updated, the charge level may be decreased by one level or may be initialized. In this way, it is possible to encourage the user to actively activate the charge shot.

(10) In the above-described embodiment, the operating character 310 moves in response to a drag operation on the touch screen 15. However, a cross key may be displayed on the touch screen 15 and the operating character 310 may be moved in response to a touch operation on the cross key.

(11) In the above-described embodiment, even if the rally (game) is completed, if the rally is in the middle of one set, the charge level is not initialized. However, although the charge level is not initialized by the end of the rally in the middle of one set, the charge level may be initialized by the end of one set.

(12) In the above-described embodiment, the gauge value of the super shot gauge G1 is maintained regardless of the end of the rally, and in the next rally, the gauge value is increased starting from the maintained gauge value each time a normal shot is performed. However, the gauge value may be initialized when a predetermined end condition (for example, an end condition that is satisfied when the rally ends) is satisfied.

(13) In the above-described embodiment, a tennis game has been described as an example. However, even in a martial arts game in which a player fights against the same opponent in each of a plurality of rounds or in an action game that can be executed until all of the plurality of lives given to an operating character are lost, the predetermined game control may be executed by a plurality of touch operations (one long-press operation and two tap operations) as in the above-described embodiment.

(14) In the above-described embodiment, after the charge shot standby state or the special shot standby state is set, the standby state cannot be canceled by the user operation. However, the standby state may be canceled in response to a specific touch operation (for example, a double-tap operation when the ball 340 is not in the hitting area 350, or a down flick operation for the hitting operation) after the standby state is set.

(15) In the above-described embodiment, a tennis game in which a single match is played has been described. However, a doubles match may be played by the operating character 310 and the NPC as a pair. In this case, the skill may be activated in the NPC according to the tap operation of the user.

(16) In the above-described embodiment, the charge shot standby state is set by tapping the shot type selection button 370 when the charge level is level 1 or higher, and is canceled by re-tapping the shot type selection button 370. However, the special shot standby state set by tapping the super shot button 360 may be canceled by re-tapping the super shot button 360, and the special shot standby state set by tapping the charge shot button 380 may also be canceled by re-tapping the charge shot button 380.

(17) In the above-described embodiment, the moving speed of the operating character 310 is controlled to a different speed depending on whether the charge shot standby state is set. However, the moving speed may be controlled to a different speed depending on whether the special shot standby state is set. That is, if the special shot standby state is not set, the moving speed may be controlled to the speed H, whereas if the special shot standby state is set, the moving speed may be controlled to the speed L slower than the speed H. The moving speed may be controlled depending on whether the special shot standby state is set rather than whether the charge shot standby state is set.

<Additional Notes>

The matters described in each of the above-described embodiments will be added below.

(Additional Note 1)

An aspect of an embodiment of the present disclosure provides a game program that is executed on a computer (the user terminal 100 in FIG. 1) including a processor, a memory, and a touch screen, the processor being caused to execute: a step (S04) of updating a value of a first parameter (charge shot gauge) while a first touch operation on the touch screen is continued; and a step (S18) of executing a first game control (charge shot) when a second touch operation is received from a user and then a third touch operation is received after the first touch operation is released.

(Additional Note 2)

The game program according to Additional Note 1, wherein the step of executing the first game control involves causing a first object to activate a first skill (charge shot) as the first game control by receiving the second touch operation and the third touch operation in a first state in which the value of the first parameter is updated to a first threshold value or higher.

(Additional Note 3)

The game program according to Additional Note 2, wherein the step of executing the first game control involves creating a first standby state (charge shot standby state) in which the first skill can be activated by receiving the second touch operation in the first state and activating the first skill by receiving the third touch operation in the first standby state.

(Additional Note 4)

The game program according to Additional Note 3, wherein the second touch operation is a touch operation on a first icon (shot type selection button) displayed on the touch screen, and the processor is caused to execute: a step (S10, S11) of shifting a display mode of the first icon to a first display mode indicating that the first standby state is set by receiving a touch operation on the first icon as the second touch operation in the first state and not shifting the display mode of the first icon to the first display mode without receiving the touch operation on the first icon as the second touch operation even when the touch operation is performed on the first icon in a state in which the value of the first parameter is less than the first threshold value.

(Additional Note 5)

The game program according to Additional Note 4, wherein the first icon is an icon for selecting a type (spin/lob, slice) of an action to be performed by the first object in response to a touch operation on the first icon, and is an icon that allows the type of an action corresponding to the first skill to be selected in the first state, the first standby state is a state in which the type of an action corresponding to the first skill is selected as the type of action, and a second icon (super shot button) different from the first icon is displayed on the touch screen, and the processor is caused to execute: a step of causing an action corresponding to the selected type to be activated in the first object by receiving a fourth touch operation in a state different from the first standby state, in which a type of another action different from the action corresponding to the first skill is selected in response to the touch operation on the first icon; and a step of creating a second standby state (special shot standby state corresponding to super shot) in which a second skill (super shot) different from the first skill can be activated in the first object by receiving a fifth touch operation on the second icon in a second state in which a first condition (activation permission condition associated with super shot) is satisfied and activating the second skill in the first object by receiving a sixth touch operation in the second standby state.

(Additional Note 6)

The game program according to Additional Note 5, wherein a third icon (gear shot icon) different from the first icon and the second icon is displayed on the touch screen, and the processor is caused to execute: a step of creating a third standby state (special shot standby state corresponding to gear shot) in which a third skill (gear shot) different from the first skill and the second skill is activated in the first object by receiving a seventh touch operation on the third icon in a third state in which a second condition (activation permission condition associated with gear shot) different from the first condition is satisfied and activating the third skill in the first object by receiving an eighth touch operation in the third standby state.

(Additional Note 7)

The game program according to any one of Additional Notes 3 to 6, wherein the processor is caused to execute: a step (S03) of exerting a disadvantageous effect on the user regarding the progress of a game in the first standby state.

(Additional Note 8)

The game program according to Additional Note 7, wherein a game based on the game program is a game that progresses by a character operated by the user, and the processor is caused to execute: a step (S03) of moving the character in response to a touch operation on the touch screen, and the step of exerting involves performing a control for decreasing a moving speed of the character to be slower than that not in the first standby state as the control for exerting the disadvantageous effect.

(Additional Note 9)

The game program according to any one of Additional Notes 2 to 8, wherein a game based on the game program is a game that progresses by moving a character in response to a user's operation, the first touch operation includes a touch operation for moving the character, the step of updating involves updating the value of the first parameter so that an update amount of the value of the first parameter when the first touch operation is being performed and the character is being moved by the first touch operation is smaller than that when the character is not moved by the first touch operation.

(Additional Note 10)

The game program according to any one of Additional Notes 2 to 9, wherein the step of updating involves maintaining the value of the first parameter updated in response to the first touch operation even after the first touch operation is released.

(Additional Note 11)

The game program according to any one of Additional Notes 2 to 10, wherein a game based on the game program is a game which progresses by operating a first object that operates in response to a user's touch operation, and in which an end condition can be satisfied a plurality of times in one game, and the step of updating involves updating the value of the first parameter in response to the first touch operation until one end condition is satisfied, initializing the value of the first parameter when the value of the first parameter is not updated to the first threshold value when the one end condition is satisfied, and maintaining thereafter a value corresponding to the first threshold value as the value of the first parameter when the value of the first parameter is updated to the first threshold value.

(Additional Note 12)

The game program according to Additional Note 11, wherein the step of updating involves: updating the value of the first parameter even after the value of the first parameter is updated to the first threshold value in response to a touch operation on the touch screen until the one end condition is satisfied; and initializing the value of the first parameter exceeding the first threshold value when the value of the first parameter exceeds the first threshold value but is not updated to a second threshold value when the one end condition is satisfied and maintaining thereafter the value corresponding to the first threshold value as the value of the first parameter, and maintaining thereafter a value corresponding to the second threshold value as the value of the first parameter when the value of the first parameter is updated to the second threshold value, and the step of executing the first game control involves receiving the second touch operation and the third touch operation in the first state to activate a skill that is more advantageous to the user as the first skill when the value of the first parameter is updated to the second threshold value than when the value of the first parameter exceeds the first threshold value but is not updated to the second threshold value.

(Additional Note 13)

The game program according to any one of Additional Notes 2 to 12, wherein a game based on the game program is a game in which a first object that operates in response to a user's touch operation and another object operated by another user compete against each other, and the processor is caused to execute: a step of notifying of information corresponding to the value of the first parameter associated with the other user based on a touch operation of the other user.

(Additional Note 14)

The game program according to any one of Additional Notes 1 to 13, wherein a game based on the game program is a game that progresses according to a positional relationship between a first object that operates in response to a user's touch operation and a second object that is different from the first object, and a condition for executing the first game control by the step of executing the first game control includes that the third touch operation is received in a state in which the first object and the second object are in a predetermined positional relationship.

(Additional Note 15)

An aspect of an embodiment of the present disclosure provides a game method executed by a computer (the user terminal 100 in FIG. 1) including a processor, a memory, and a touch screen, the computer executing: a step (S04) of updating a value of a first parameter (charge shot gauge) while a first touch operation on the touch screen is continued; and a step (S18) of executing a first game control (charge shot) when a second touch operation is received from a user and then a third touch operation is received after the first touch operation is released.

(Additional Note 16)

An aspect of an embodiment of the present disclosure provides an information processing device (the user terminal 100 in FIG. 1) including: a storage unit (120 in FIG. 3) that stores a game program; and a control unit (110 in FIG. 3) that controls an operation of the information processing device by executing the game program, the control unit executing: a step (S04) of updating a value of a first parameter (charge shot gauge) while a first touch operation on the touch screen is continued; and a step (S18) of executing a first game control (charge shot) when a second touch operation is received from a user and then a third touch operation is received after the first touch operation is released.

[Software-based implementation example] The control in each of the user terminal 100 and the server 200 may be realized by a logic circuit (hardware) formed in an integrated circuit (IC chip) or the like, or may be realized by software.

In the latter case, the user terminal 100 and the server 200 include a computer that executes program commands that are software that realizes each function. The computer includes, for example, one or more processors and includes a computer-readable recording medium that stores the program. In the computer, the processor reads the program from the recording medium and executes the program, whereby the object of the present invention is achieved. As the processor, for example, a central processing unit (CPU) can be used. As the recording medium, a “non-transitory tangible medium”, for example, a read only memory (ROM) or the like, a tape, a disk, a card, a semiconductor memory, a programmable logic circuit, or the like can be used. Further, the computer may further include a random access memory (RAM) for expanding the above-mentioned program. The program may be supplied to the computer via any transmission medium (communication network, broadcast wave, and the like) capable of transmitting the program. It should be noted that one aspect of the present invention can also be realized in the form of a data signal embedded in a carrier wave, in which the above-mentioned program is embodied by electronic transmission.

The present invention is not limited to the above-described embodiments, but can be altered in many ways within the scope of the claims. An embodiment derived from a proper combination of technical means disclosed in different embodiments is also encompassed in the technical scope of the present invention.

### REFERENCE SIGNS LIST

1 Game system,
2 Network,
10, 20 Processor,
11, 21 Memory,
12, 22 Storage,
15 Touch screen,
151 Input unit,
152 Display unit,
17 Camera,
18 Distance measuring sensor,
1010 Object,
1020 Controller,
1030 Storage medium,
100 User terminal,
200 Server,
120, 220 Storage unit,
121,221 Game program,
122,222 Game information,
123,223 User information,
110, 210 Control unit,
111 Game progress processing unit,
112 Input operation receiving unit,
113 Camera arrangement control unit,
114 Display control unit,
115 Object control unit,
211 Transmitting/receiving unit,
212 Server processing unit,
213 Data management unit,
214 Synchronization processing unit

1. A non-transitory computer-readable storage medium storing a game program that is executed on a computer including a processor, a memory, and a touch screen, the processor being caused to execute:
a step of updating a value of a first parameter while a first touch operation on the touch screen is continued; and
a step of executing a first game control when a second touch operation is received from a user and then a third touch operation is received after the first touch operation is released.

2. The non-transitory computer-readable storage medium according to claim 1, wherein
the step of executing the first game control involves causing a first object to activate a first skill as the first game control by receiving the second touch operation and the third touch operation in a first state in which the value of the first parameter is updated to a first threshold value or higher.

3. The non-transitory computer-readable storage medium according to claim 2, wherein
the step of executing the first game control involves creating a first standby state in which the first skill can be activated by receiving the second touch operation in the first state and activating the first skill by receiving the third touch operation in the first standby state.

4. The non-transitory computer-readable storage medium according to claim 3, wherein
the second touch operation is a touch operation on a first icon displayed on the touch screen, and
the processor is caused to execute:
a step of shifting a display mode of the first icon to a first display mode indicating that the first standby state is set by receiving a touch operation on the first icon as the second touch operation in the first state and not shifting the display mode of the first icon to the first display mode without receiving the touch operation on the first icon as the second touch operation even when the touch operation is performed in a state in which the value of the first parameter is less than the first threshold value.

5. The non-transitory computer-readable storage according to claim 4, wherein
the first icon is an icon for selecting a type of an action to be performed by the first object in response to a touch operation on the first icon, and is an icon that allows the type of an action corresponding to the first skill to be selected in the first state,
the first standby state is a state in which the type of an action corresponding to the first skill is selected as the type of action, and
a second icon different from the first icon is displayed on the touch screen, and
the processor is caused to execute:
a step of causing an action corresponding to the selected type to be activated in the first object by receiving a fourth touch operation in a state different from the first standby state, in which a type of another action different from the action corresponding to the first skill is selected in response to the touch operation on the first icon; and
a step of creating a second standby state in which a second skill different from the first skill can be activated in the first object by receiving a fifth touch operation on the second icon in a second state in which a first condition is satisfied and activating the second skill in the first object by receiving a sixth touch operation in the second standby state.

6. The non-transitory computer-readable storage medium according to claim 5, wherein
a third icon different from the first icon and the second icon is displayed on the touch screen, and
the processor is caused to execute:
a step of creating a third standby state in which a third skill different from the first skill and the second skill is activated in the first object by receiving a seventh touch operation on the third icon in a third state in which a second condition different from the first condition is satisfied and activating the third skill in the first object by receiving an eighth touch operation in the third standby state.

7. The non-transitory computer-readable storage medium according to claim 6, wherein
the processor is caused to execute:
a step of exerting a disadvantageous effect on the user regarding progress of a game in the first standby state.

8. The non-transitory computer-readable storage medium according to claim 7, wherein
a game based on the game program is a game that progresses by a character operated by the user, and
the processor is caused to execute:
a step of moving the character in response to a touch operation on the touch screen, and
the step of exerting involves performing a control for decreasing a moving speed of the character to be slower than that not in the first standby state as the control for exerting the disadvantageous effect.

9. The non-transitory computer-readable storage medium according to claim 8, wherein
a game based on the game program is a game that progresses by moving a character in response to a user's operation,
the first touch operation includes a touch operation for moving the character,
the step of updating involves updating the value of the first parameter so that an update amount of the value of the first parameter when the first touch operation is being performed and the character is being moved by the first touch operation is smaller than that when the character is not moved by the first touch operation.

10. The non-transitory computer-readable storage medium according to claim 9, wherein
the step of updating involves maintaining the value of the first parameter updated in response to the first touch operation even after the first touch operation is released.

11. The non-transitory computer-readable storage medium according to claim 10, wherein
a game based on the game program is a game which progresses by operating a first object that operates in response to a user's touch operation, and in which an end condition can be satisfied a plurality of times in one game, and
the step of updating involves updating the value of the first parameter in response to the first touch operation until one end condition is satisfied, initializing the value of the first parameter when the value of the first parameter is not updated to the first threshold value when the one end condition is satisfied, and maintaining thereafter a value corresponding to the first threshold value as the value of the first parameter when the value of the first parameter is updated to the first threshold value.

12. The non-transitory computer-readable storage medium according to claim 11, wherein
the step of updating involves:
updating the value of the first parameter even after the value of the first parameter is updated to the first threshold value in response to a touch operation on the touch screen until the one end condition is satisfied; and
initializing the value of the first parameter exceeding the first threshold value when the value of the first parameter exceeds the first threshold value but is not updated to a second threshold value when the one end condition is satisfied and maintaining thereafter the value corresponding to the first threshold value as the value of the first parameter, and maintaining thereafter a value corresponding to the second threshold value as the value of the first parameter when the value of the first parameter is updated to the second threshold value, and
the step of executing the first game control involves receiving the second touch operation and the third touch operation in the first state to activate a skill that is more advantageous to the user as the first skill when the value of the first parameter is updated to the second threshold value than when the value of the first parameter exceeds the first threshold value but is not updated to the second threshold value.

13. The non-transitory computer-readable storage medium according to claim 10, wherein
a game based on the game program is a game in which a first object that operates in response to a user's touch operation and another object operated by another user compete against each other, and
the processor is caused to execute:
a step of notifying of information corresponding to the value of the first parameter associated with the other user based on a touch operation of the other user.

14. The non-transitory computer-readable storage according to claim 10, wherein
a game based on the game program is a game that progresses according to a positional relationship between a first object that operates in response to a user's touch operation and a second object that is different from the first object, and
a condition for executing the first game control by the step of executing the first game control includes that the third touch operation is received in a state in which the first object and the second object are in a predetermined positional relationship.

15. A game method executed by a computer including a processor, a memory, and a touch screen, the computer executing:
a step of updating a value of a first parameter while a first touch operation on the touch screen is continued; and
a step of executing a first game control when a second touch operation is received from a user and then a third touch operation is received after the first touch operation is released.

16. An information processing device comprising:
a storage unit that stores a game program; and
a control unit that controls an operation of the information processing device by executing the game program, the control unit executing:
a step of updating a value of a first parameter while a first touch operation on a touch screen is continued; and
a step of executing a first game control when a second touch operation is received from a user and then a third touch operation is received after the first touch operation is released.

17. The game method according to claim 15, wherein
the step of executing the first game control involves causing a first object to activate a first skill as the first game control by receiving the second touch operation and the third touch operation in a first state in which the value of the first parameter is updated to a first threshold value or higher.

18. The game method according to claim 17, wherein
the step of executing the first game control involves creating a first standby state in which the first skill can be activated by receiving the second touch operation in the first state and activating the first skill by receiving the third touch operation in the first standby state.

19. The game method according to claim 18, wherein
the second touch operation is a touch operation on a first icon displayed on the touch screen, and
the processor is caused to execute:
a step of shifting a display mode of the first icon to a first display mode indicating that the first standby state is set by receiving a touch operation on the first icon as the second touch operation in the first state and not shifting the display mode of the first icon to the first display mode without receiving the touch operation on the first icon as the second touch operation even when the touch operation is performed in a state in which the value of the first parameter is less than the first threshold value.

20. The game method according to claim 19, wherein
the first icon is an icon for selecting a type of an action to be performed by the first object in response to a touch operation on the first icon, and is an icon that allows the type of an action corresponding to the first skill to be selected in the first state,
the first standby state is a state in which the type of an action corresponding to the first skill is selected as the type of action, and
a second icon different from the first icon is displayed on the touch screen, and
the processor is caused to execute:
a step of causing an action corresponding to the selected type to be activated in the first object by receiving a fourth touch operation in a state different from the first standby state, in which a type of another action different from the action corresponding to the first skill is selected in response to the touch operation on the first icon; and
a step of creating a second standby state in which a second skill different from the first skill can be activated in the first object by receiving a fifth touch operation on the second icon in a second state in which a first condition is satisfied and activating the second skill in the first object by receiving a sixth touch operation in the second standby state.
